(19) United States
(12) Patent Application Publication
(10) Pub. No.: US 2026/0216863 A1
(43) Pub. Date: Jul. 30, 2026

(54) SYSTEMS, METHODS AND SUSPENDABLE ROBOTIC DEVICES FOR MANIPULATING OBJECTS

(71) Applicant: FOLDIBOT SOLUTIONS LTD, Ramat-Gan (IL)

(72) Inventors: Liran ELIHAY, Ramat-Gan (IL); Gil VITENBERG, Ra'anana (IL)

(21) Appl. No.: 19/144,964

(22) PCT Filed: Dec. 26, 2023
(86) PCT No.: PCT/IL2023/051311

§ 371 Date: Jul. 1, 2025

Related U.S. Application Data
(60) Provisional application No. 63/478,507, filed on Jan. 5, 2023.

(51) Int. Cl. B25J 9/00; B25J 9/16; B25J 11/00; B25J 13/08; D06F 89/02

(52) U.S. Cl. CPC B25J 9/0078; B25J 9/1615; B25J 9/163; B25J 9/1674; B25J 11/008; B25J 13/089; D06F 89/02

(57) ABSTRACT

Systems, methods and suspendable robotic devices for manipulating objects. A robotic system (RS) including a suspendable robotic device (SRD) which is a robot that is suspendable by one or more suspension cables. The RS may also be configured for measuring properties of an object such as for sensing properties of each object selected to be manipulated, and generate a customized per-object manipulation plan, according to which the SRD is controlled for manipulating the respective object in a per-object customized manner. The SRD may include a length adjustment subsystem for controlling SRD body positioning by controlling length of its suspension cables and optionally also a displacement subsystem for enabling additional positioning (orientation) adjustment and control of the SRD body and/or end effector(s) thereof. The RS may be configured for folding and/or unfolding of foldable objects such as fabrics, laundry garments etc.

### TECHNICAL FIELD

Aspects of the present invention generally relate to suspendable robotic devices, suspendable from one or more suspension cables and systems and methods for controlling suspendable robotic devices for moving and/or manipulating one or more objects such as for folding of foldable/flexible elements such as fabrics, garments, etc.

### BACKGROUND

Suspendable robots (also known as “cable driven robots”) use suspension cables, each fixedly attached to supports such as a support frame, support bar or a wall, for controlling positioning of the robot's body by controlling length of each cable.

Cable driven robots are commonly used in various industries for controllably moving, handling, positioning and/or visual inspection of objects.

Suspendable robots often include one or more controllable end effectors such as a gripper or an arm for releasably gripping of objects to be handled or moved.

The positioning of the gripper/arm/end effector or entire robot body is typically controlled by controlling length of each of the cables from which the object/robot is suspended usually by using winches, each designed to hold a different cable end portion, where the length of each cable is controlled by rotating of its respective spool. Controlling of the robot positioning in an external XYZ coordinate system is dynamically complex, especially when the number of cables used is lower than the number of degrees-of-freedom of the robot (i.e., robot is underactuated).

### SUMMARY

Aspects of disclosed embodiments pertain to a robotic system (RS) for manipulating of objects, the robotic system comprising at least:
(i) a suspendable robotic device (SRD) comprising at least:
at least one suspension cable configured to be anchored, from a distal side thereof, to a support structure;
at least one length-adjustment (LA) subsystem comprising at least:
at least one reel, wherein each suspension cable is releasably wrapped, from a proximal side thereof, around the at least one reel of a corresponding LA subsystem; and
at least one LA motor, wherein each LA motor is operatively associated with a different corresponding at least one of a different LA subsystem, each LA motor being configured to controllably adjust length of a corresponding suspension cable of the SRD, by controllably rotating of the corresponding at least one reel of the corresponding LA subsystem, for controlling an overall positioning of the SRD in respect to a fixed external three-dimensional (3D) coordinate system; and
at least one displacement subsystem comprising at least one displacement (Dis.) motor positioned and configured to controllably and separately displace a 3D point in an internal 3D coordinate system of the SRD, from which a corresponding suspension cable extends towards its corresponding support structure;
a manipulation subsystem comprising at least one end effector and one or more operation motors configured at least for controlling state of the at least one end effector;
(ii) a detection subsystem comprising at least one sensor and configured to detect one or more properties of the SRD, one or more objects to be handled by the robotic system and/or surrounding environment of the robotic system; and
(iii) a control subsystem comprising one or more control units, at least one of the one or more control units being configured at least to:
receive and analyze sensor data arriving from the at least one sensor to determine one or more characteristics of the SRD and/or one or more objects in their surrounding environment; and
control at least the state of each of the at least one end effector of the manipulation subsystem, by controlling operation of motors of the LA subsystem, the displacement subsystem and the manipulation subsystem.

Other aspects of disclosed embodiments pertain to a method for handling/manipulating of one or more objects, the method comprising at least:
(i) providing a robotic system that includes a SRD;
(ii) receiving updated sensor data from one or more of the sensors of the robotic system;
(iii) analyzing the received updated sensor data to determine object properties of an object;
(iv) determining object properties of the respective object, based on analysis of the received updated sensor data;
(v) generating a customized manipulation plan for the respective object, based at least on determined object properties of the respective object;
(vi) manipulating the respective object by controlling one or more timed operations of the SRD of the robotic system, done by controlling operation of at least one of: operation and state of the at least one end effector of the SRD, positioning of the SRD body, based on the determined customized manipulation plan of the respective object.

Additional or alternative aspects of disclosed embodiments, pertain to a robotic system (RS) for manipulating of foldable elements such as fabrics, laundry garments, etc., where the robotic system comprising at least:
(i) a suspendable robotic device (SRD) comprising at least:
at least one suspension cable configured to be anchored, from a distal side thereof, to a corresponding support structure;
at least one length-adjustment (LA) subsystem comprising at least:
at least one reel setup, each reel setup comprising at least one reel, wherein each suspension cable is releasably wrapped, from a proximal side thereof, around at least one of the at least one reel of a corresponding reel setup; and
at least one LA motor, wherein each LA motor is operatively associated with a different corresponding reel setup, each LA motor being configured to controllably adjust length of a different corresponding suspension cable of the SRD, by controllably rotating of the corresponding at least one reel of the corresponding reel setup, for controlling an overall positioning of the SRD in respect to a fixed external three-dimensional (3D) coordinate system; and
a manipulation subsystem comprising at least one gripper and one or more operation motors configured at least for controlling gripping state of the at least one gripper;
(ii) a detection subsystem comprising at least one sensor and is configured to detect one or more properties of the SRD and its surrounding environment; and
(iii) a control subsystem comprising one or more control units, at least one of the one or more control units being configured at least to: receive and analyze sensor data arriving from the at least one sensor to determine one or more characteristics of the SRD and/or its surrounding environment; and control at least position and state of each of the at least one gripper by controlling motors of the LA subsystem and the manipulation subsystem.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 show a schematic illustration of a robotic system (RS) that includes a suspendable robotic device (SRD) that is suspended from walls of a room, according to some embodiments;

FIGS. 2A-2B show an illustration of the SRD of the RS or parts thereof: FIG. 2A shows a side of the SRD with part of its casing exposed to show one of each of a length adjustment (LA) subsystem and a displacement subsystem of the SRD, according to some embodiments; and FIG. 2B shows a more exposed view showing all three LA and displacement subsystems of the SRD;

FIG. 3 shows a schematic illustration of a braking mechanism embedded in each pair of combined LA and displacement subsystems of the SRD, according to some embodiments;

FIGS. 4A-4B show one embodiment of an anchoring device that includes two interlocking parts, where the anchoring device can be used for releasably anchoring of a corresponding suspension cable of the SRD to a support structure such as a wall: FIG. 4A shows an elevated perspective view of the anchoring device in a released state; and FIG. 4B shows an elevated perspective view of the anchoring device in an interlocked (suspension) state;

FIG. 5 shows a block diagram of several main modules and units of the robotic system, according to some embodiments;

FIG. 6 shows how the SRD can be used for manipulation of foldable elements such as for fabrics' folding and/or sorting, and the like, according to some embodiments;

FIG. 6A shows a zoom-in view of an illustration of an auxiliary apparatus having at least one side thereof including a pattern that can be used for assisting autonomous object-properties detection and/or for physically assisting in the actual manipulation (e.g. sorting, moving, folding, etc.) of the object, according to some embodiments.

FIG. 7 shows a flowchart, schematically illustrating a general process of using a robotic system that is designed for folding of foldable objects, according to some embodiments;

FIGS. 8A-8C show details of three sequential procedures of a fabrics folding session done by a SRD of a robotic system, specially designed for automatic/autonomous folding of foldable objects, according to some embodiments: FIG. 8A shows a flowchart, schematically illustrating steps of an initial pre-folding (preparation) procedure of the folding process, according to some embodiments; FIG. 8B shows a flowchart, schematically illustrating steps of a folding procedure of the folding process, according to some embodiments; and FIG. 8C shows a flowchart, schematically illustrating steps of a stacking (post-folding) procedure actions, according to some embodiments; and

FIG. 9 is a flowchart, schematically illustrating a process of manipulating one or more objects by using a robotic system with a SRD, by generating a per-object customized manipulation control, according to some embodiments.

### DETAILED DESCRIPTION OF SOME EMBODIMENTS

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “analyze”, “process”, “control”, “adjust” and/or any conjugations and/or synonyms thereof, include action, instruction, operation and/or processes of at least one processor and/or of at least one computer that manipulates and/or transforms data into other data, and/or that uses signals and/or data to physically operate a machine or part thereof, said data/signals represented as physical quantities, e.g. such as electronic quantities such as electronic and/or optical signals etc., and/or said data representing the physical objects. The terms “computer”, “processor”, and/or “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), Tensor Processing Unit (TPU) etc.), a group of multiple physical machines sharing performance of various tasks, virtual servers co-residing on a single physical machine, any other electronic computing device, and/or any combination thereof.

The operations in accordance with the teachings herein may be performed and/or enabled by at least one computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance”, “according to some embodiments” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter, fewer, more and/or different stages, components and/or purposes than those shown in the figures or specified in this Description may be required in order to fully accomplish desired outcomes. The Figures and Description of embodiments are used to clarify embodiments/examples of main features, components, designs, structures and/or actions required for a person of average skills in the art to understand the main principles required for constructing, using, building and/or performing actions of these embodiments.

The symbol “/” used herein may refer to and and/or expression.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium

Aspects of disclosed embodiments, pertain to systems, methods and suspendable robotic devices for manipulating objects such as for folding of foldable objects such as fabrics, garments of a laundry garments pile, etc.

According to some embodiments, there is provided a robotic system (RS) including a suspendable robotic device (SRD) which is a robot that is suspendable by one or more suspension cables. The robotic system may be configured for measuring properties of each object to be manipulated such as a selected garment to be folded by the SRD, and generate a customized per-object manipulation (folding) plan according to which the SRD is controlled for manipulating (folding) the respective object (selected garment) in a per-object customized manner.

Aspects of disclosed embodiments pertain to systems, methods and suspendable robotic devices that enable controlling positioning (i.e., position and orientation state) of suspendable (cable driven) robotic devices that can be used for various purposes such as for gripping and positioning of various types of objects, for manipulating objects such as for assembling and/or connecting of objects, stacking of objects, manipulating of objects such as for painting/spraying of objects and/or for folding of objects such as for folding of fabrics, inspection of objects and/or for sorting of fabric objects, etc.

It is to be understood that the term “positioning” used herein may refer to a position and/or orientation of a body/object in a reference coordinate system (could be a global or a local reference coordinate system).

According to some embodiments, any one or more of the robotic system and/or SRD thereof may be designed to be controlled in a manual, autonomous, semi-autonomous, automatic and/or semi-automatic manner.

According to some embodiments, there is provided a robotic system (RS) that may include:
(i) a suspendable robotic device (SRD) comprising at least one or more of:
at least one suspension cable configured to be removably fastened, at a distal side thereof, to a corresponding support structure, by an anchoring device;
at least one (e.g., per suspension cable) length-adjustment (LA) subsystem that may include several (per-cable) reel setups, where each reel setup may include at least one reel, for having each suspension cable of the SRD be releasably wrapped, from a proximal side thereof, around a different corresponding reel of its corresponding reel setup; at least one LA motor, operatively associated with a different corresponding reel setup, each LA motor being configured to controllably adjust length of a different corresponding suspension cable, by controllably rotating of the corresponding reel of the corresponding reel setup, for controlling an overall positioning of the SRD in respect to a fixed external three-dimensional (3D) coordinate system, where at least one of the LA motors of the SRD, may be installed externally to other parts of the SRD, alternatively all motors may be embedded in the SRD and suspendable therewith;
(ii) a manipulation subsystem comprising at least one end effector such as at least one gripper and one or more operation motors configured at least for controlling state of the at least one end effector and optionally to additionally control other operation features/characteristics of each end effector such as gripping strength, end effector positioning, force applied by the end effector onto an object etc.;
(iv) a detection subsystem comprising at least one sensor (embedded in the SRD and/or externally positioned in respect to the SRD), the detection subsystem being configured to detect one or more properties of the SRD and its surrounding environment for enabling to determine updated positioning and functioning of the SRD e.g., in respect to an object the SRD is to handle for enabling to determine next positioning and other control actions required;
(v) a control subsystem including at least one control unit, each control unit configured to perform at least one or more of the following steps/actions:
receive and analyze updated sensor data (e.g., in real time or near real time) arriving from the at least one sensor to determine one or more characteristics of the SRD and/or its surrounding environment such as properties of one or more objects in its surrounding environment;
determine required positioning and/or action(s) of one or more of its end effectors e.g., based on analysis of the updated sensor data (e.g., in real time or near real time relative to the time of receiving the updated sensor data); and
control at least position and state of each of at least one of its one or more end effectors by controlling motors of the LA subsystem and/or of the manipulation subsystem.

The terms “suspension cable(s)” and “cable(s)” may be interchangeably used herein.

The term “reel” used herein, may refer to any type of artifact, element or device that has a cylindrical component designed for having a cable wrapped over its outer side such as a spool, a winch, a rod, a cylinder, a pulley, wheel, and the like.

The term “pulley” or “a cable guide element (CGE)” used herein may refer to any object that is designed to engage with a suspension cable over an external surface thereof and rotate in response to forces applied by the cable engaging thereof.

The term “sensor data” used herein, may refer to digital, optical and/or electrical data and/or signals that are outputted by the one or more sensors of the robotic system and/or to digital data of sensor(s) output after being converted for example from electrical or optical signal(s) into digital data. The term “analysis” or “processing” of sensor data may refer to any processing of data and/or signals done by use of one or more software and/or hardware processing/analysis means.

The term “end effector” used herein, may refer to any tool, device, mechanism, machine, apparatus and/or object that is designed to perform any one or more operations such as for gripping, fastening, drilling, applying force, screwing, clutching, connecting, heating/cooling, ironing, measuring, delivering/transporting of objects, etc.

The end effector may include for example one or more of: at least one gripper, at least one arm, at least one driller, at least one connector, at least one screw driver, and the like.

Each end effector(s) of the RS may be operable via a different designated operation motor or via a same operation motor.

The operation of each end effector by the operation motor may be done via one or more actuation and/motion translation means such as via a gear subsystem and a drive shaft and the like.

The end effector may include any apparatus and/or device that is configured at least for releasable gripping, holding, lifting, handling, applying of force(s) and/or manipulating of one or more objects, such as, yet not limited to one or more of: a clips device, a fastener, a hook, a robotic arm, a position-controlled element, a hard drive tool, an ironing device etc.

The term “manipulating” and/or the term “handling” of one or more objects may be used interchangeably herein and may refer to, yet not limited to, any one or more of: connecting of objects, covering/coating one or more objects with a material, folding of objects, sorting of objects, stacking of objects, applying pressure over the one or more objects, lifting of one or more objects, displacing/moving of one or more objects from one positioning/place to another, hanging, operating, inspection and/or monitoring of objects, illumination of objects, and the like.

The term “motor(s)” used herein, may relate to any type of a controllable machine that enables applying of a physical force such as torque or linear force over any one or more other elements moved (e.g., rotated or linearly moved) thereby, such as an electrical motor(s).

According to some embodiments the one or more control units of the control subsystem and/or one or more of the at least one detection subsystem, may use any one or more hardware and/or software means (e.g., processor(s), printed circuit board(s) (PCB(s)) and/or algorithm(s)), one or more of these means being optionally specially programmed, configured and/or designed for carrying out specially designed/programmed and/or programmable/adjustable actions. For example, one or more of the control units and/or sensor(s) may be configured in a programmable manner, by using micro-electromechanical system(s) (MEMS(s)) devices that can be specifically programmed to perform command-based actions and/or generate commands for automatically and separately controlling of each of the motors of the robotic system.

According to some embodiments the robotic system may further include at least one displacement subsystem comprising at least one displacement (Dis.) motor positioned and configured to controllably and separately displace a 3D point in an internal 3D coordinate system of the SRD, from which the corresponding cable extends towards its respective anchoring point.

According to some embodiments, the one or more displacement subsystems of the SRD may be designed to enable/improve control over the orientation (pitch and/or roll) of the SRD's body and/or of its one or more of end effectors and/or SRD sensors, thereby increasing the movement degrees of freedom of the SRD.

According to some embodiments, the robotic system is configured for folding of fabrics, and may be configured such that the detection subsystem is configured to detect one or more physical properties of each object to be folded and the control subsystem may be configured to determine (based on received and analyzed updated sensor data) properties of each object (herein “object-properties”); and to control all the motors and/or actuators of the robotic system, based on detected one or more object-properties; as well as to select, adjust and/or determine a folding plan or a set of control instructions and/or actions that are required for folding and stacking of the specific detected object, optionally in real time or near real time and/or in a controllable, automatic, semi-automatic, autonomous and/or semi-autonomous manner.

According to some embodiments, the control subsystem may include one or more preset and optionally adjustable/programmable folding plans, one or more for each object type, shape, dimensions and/or size.

According to some embodiments, each folding plan may be programmed such as to receive updated sensor data and set or calculate, based on the received updated sensor data and/or determined object-properties, one or more values of one or more parameters of the folding plan such as to customize the plan to the specific object and object-properties thereof.

According to some embodiments, each customized folding plan may include a set of chronologically and/or sequentially ordered (executable) actions to be executed/performed by the SRD, according to the order they are organized by.

According to some embodiments, the control subsystem may include one or more algorithms/programs that are configured to be operable via one or more hardware and/or software based modules, for analyzing received updated sensor data that is received (e.g., in real time or near real time) from the one or more sensors of the respective detection subsystem, such as one or more of: an image processing program(s)/algorithm(s) designed for identification/determination of object properties such as size, shape, dimensions, classification, type, positioning (including location and orientation) of the object(s) to be handled by the robotic system, in the external 3D coordinate system, relative positioning between the object the SRD and/or the end effector(s) thereof and the like. The folding or any other action required to be done for handling/manipulating of the object may be adjusted/set according to the determined object/object-properties.

According to some embodiments, in which the robotic system is used for objects folding, the control subsystem may be further configured to determine a related-entity with which the object is associated. For example, the robotic system may be configured to determine to which member of the family or to which storage unit or object-type the object is related to, and stack the object it folds in a designated stack that is associated with a corresponding related-entity identified by the control subsystem (e.g., one stack for a first member of the family another for a second member etc. and other stacks for other entity types such as for separate double and single beds' linen, another stack for tablecloths, etc.).

According to some embodiments the RS may be designed to allocate and/or form several stacks that can be associated with the same related-entity e.g., when the stack already formed for that entity is too high/large.

According to some embodiments, the term “spread” or any other linguistic conjugation thereof, used herein, may refer to any action of straightening, stretching, ironing and/or unfolding of the specific object.

According to some embodiments, the detection and/or control subsystems may be programmed to first perform one or more initial actions/steps/procedures. For example, the detection and/or control subsystems may be programmed to first pick into and identify in the pile of objects all objects that are of a type that is designated to be paired with a corresponding pairing-object such as all socks-typed objects and place them in a separate pile for pairing each such object with its corresponding pairing-object before folding thereof. Once pairs of such objects are separated from the main laundry pile, they can be folded in pairs.

Once the selected object is folded, it may be picked in a folded state and moved to another location designated for stacking thereof, e.g., according to its associated related-entity or left at the same place it was folded selecting a different “folding area” for the next object to be folded. The moving and stacking and/or selection of a new folding area may also be done according to the folding plan, such that this plan may also include one or more (adjusted/adjustable) stacking actions' instructions.

According to some embodiments, the RS and SRD may be designed to be partially or completely autonomous, such that all actions done by the SRD are automatically and autonomously performed thereby without requiring human intervention. In some cases, a human user may only be required to instruct the SRD and/or the robotic system to begin its autonomous operation at will e.g., by pressing an activation control button in a user interface, and/or wireless mobile interface of the RS. Once the RS is activated all its operations may be autonomously performed.

According to some embodiments, operation of a laundry folding session may be initiated by the user by placing one or more auxiliary apparatuses over the folding area, such that the robotic system may detect the user's gesture and/or position of the auxiliary apparatus and automatically initiate a folding session.

The term “folding plan” used herein may be accomplished or implemented by use of one or more hardware and/or software means.

According to some embodiments, the detection subsystem may include one or more types of sensors and/or positioning systems that enable detection of SRD and/or end effector(s) positioning and/or functionality state and of one or more physical properties of an external area (environment) surrounding the SRD and/or the object(s) to be handled thereby and perform these actions by controlling the state and/or positioning of the SRD and/or of the end effector(s) thereof. For example, the detection subsystem may include one or more of the following sensor/detection devices types: camera, 3D optical sensor, gyroscope, accelerometer, LIDAR, 3D points cloud sensor, proximity sensor, pressure sensor, piezoelectric sensor, tactile sensor, magnetometer, thermometer, humidity sensor, optical detector, etc. One or more of the sensor(s) and/or detector(s) of the robotic system may be embedded within the SRD and/or externally located therefrom.

According to some embodiments the detection subsystem may further include at least one pattern projector, for determining sizes, shapes and other properties of objects by detecting pattern(s) of a known scale and proportions, projected over the object to be handled (such as garment/fabric to be folded) for enabling determination of 2D and/or 3D perspective and dimensions of the object to be handled.

The RS may be completely designed as a single SRD, such that the detection subsystem and control unit(s) are all embedded within the SRD. In other embodiments, one or more of the RS's devices may be external to the SRD, such as one or more of its sensors, control units, processors and/or user interface, display and/or input device(s) or input panel thereof and/or one or more of the sensors of the robotic system, etc.

According to some embodiments, e.g., in which the RS is used for objects' (fabrics/laundry) folding, one or more auxiliary apparatuses may be required for determining size and dimensions of each unfolded object to be folded. For example, the auxiliary apparatus(s) may include one or more rigid element of a known size, shape and dimensions optionally having a printed, embossed or engraved shape(s) or pattern thereover of known dimensions, shape and/or size such as a checkerboard pattern in which each square is of a known length and width, a ruler scaling indication, optical markers (such as IR reflectors, physical markers, projected markers etc.), etc.

According to some embodiments, the auxiliary apparatus may have a 2D or a 3D shape that can assist in identification of 3D orientation of the object in respect to the SRD or the sensor(s) (such as an optical sensor) used for measuring the auxiliary apparatus and object.

According to some embodiments, one or more auxiliary apparatuses may be used by the SRD for assisting the SRD in the actual folding and/or pre-folding procedures. For example, a rectangular (optionally elongated) auxiliary apparatus (AA) may be held by the gripper end effector(s) of the SRD and moved along the object's fabric for spreading the object, and optionally also used for forming or marking folding lines' position/location over the object. The object may then be placed in a position that enables the SRD to fold the object thereby.

According to some embodiments one or more AAs may also include one or more identification devices such as one or more transmitters (such as radio-frequency identification (RFID) devices), magnetic elements (magnets) etc., for enabling sensor(s) of the robotic system to identity/determine object-properties such as the size, shape, dimensions and/or relative positioning of the AA in respect to the specific object and/or to the SRD gripper(s) during the pre-folding and/or the folding procedure.

The term “internal coordinate system”, “3D internal coordinate system”, “3D internal x′y′z′ coordinate system” or “internal x′y′z′ coordinate system” interchangeably usable herein may refer to a three-dimensional (3D) coordinate system that moves along with a body of the SRD.

The term “external coordinate system”, “3D external coordinate system”, “3D external xyz coordinate system”, or “external xyz coordinate system” interchangeably usable herein may refer to a 3D coordinate system that is fixated and external to the SRD optionally wherein its Z axis is parallel to the gravitational force direction. This external 3D coordinate system does not change along with movement of the SRD body.

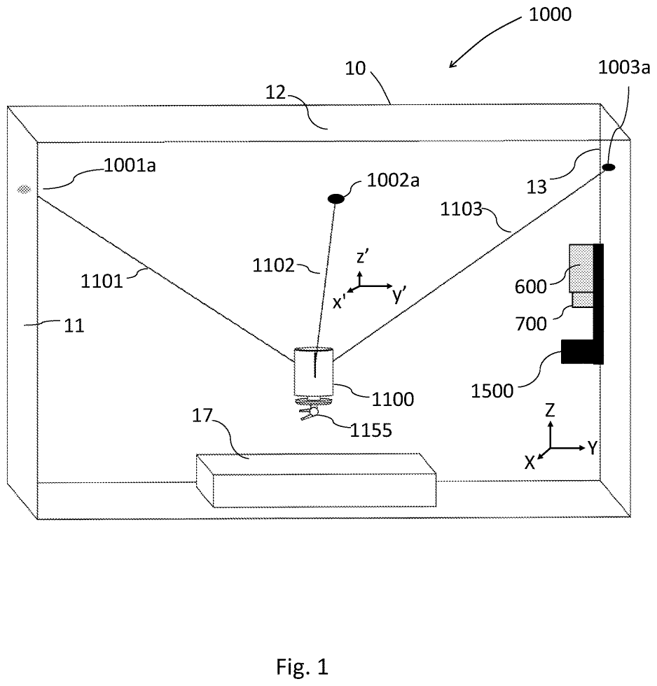

Reference is now made to FIGS. 1 and 2A-2B, and 6, showing schematic illustrations of a robotic system 1000 or part thereof, according to some embodiments. The robotic system 1000 may include a SRD 1100 using an embedded internal control unit and optionally also an external control unit 600 and an external detection unit 700 comprising one or more external sensors such as a camera or a 3D (points cloud) optical detector, etc.

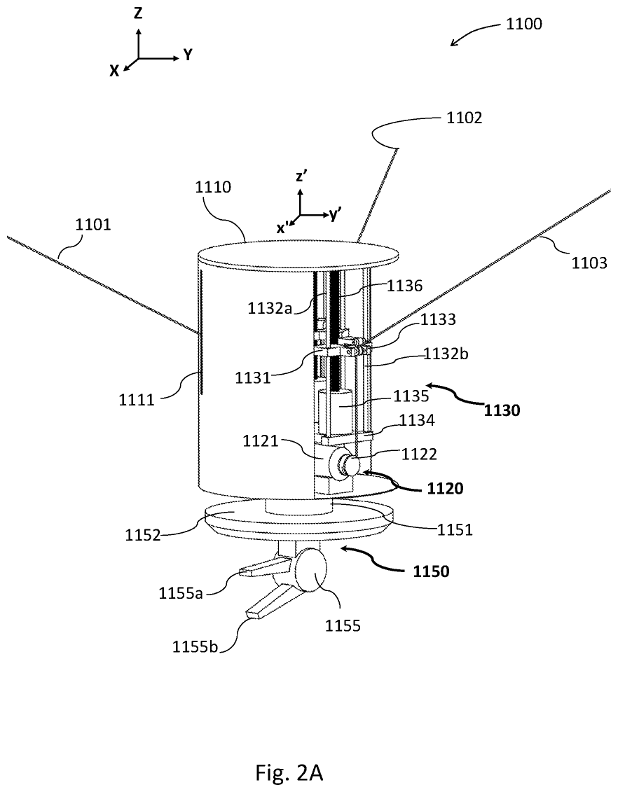

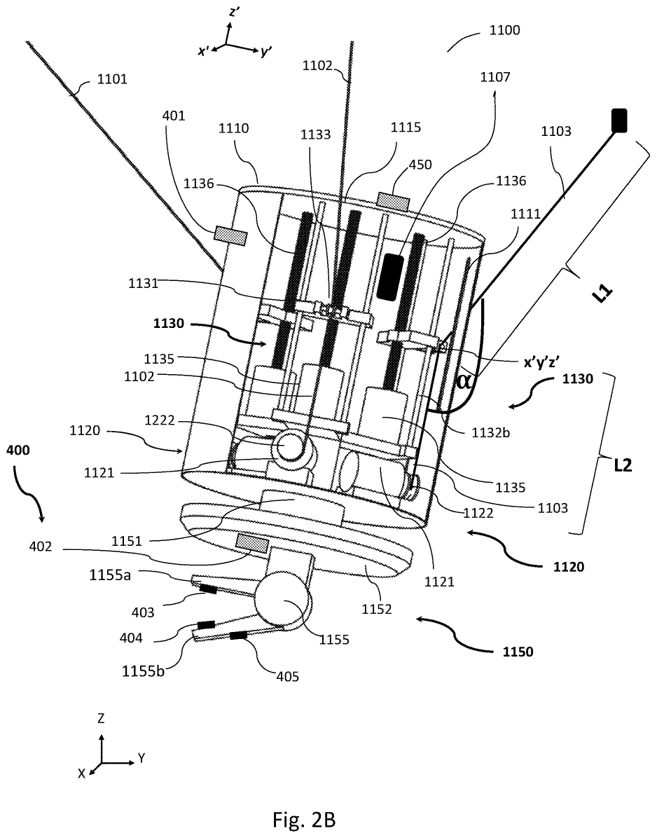

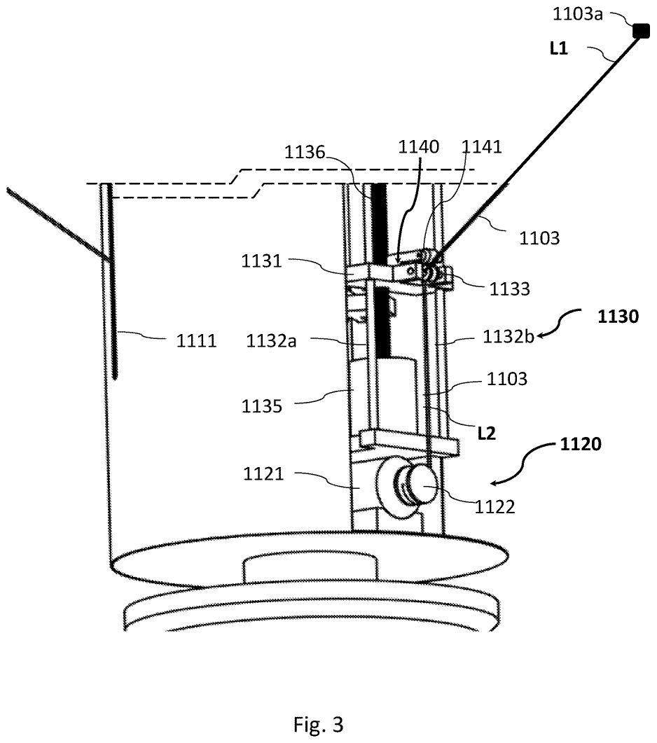

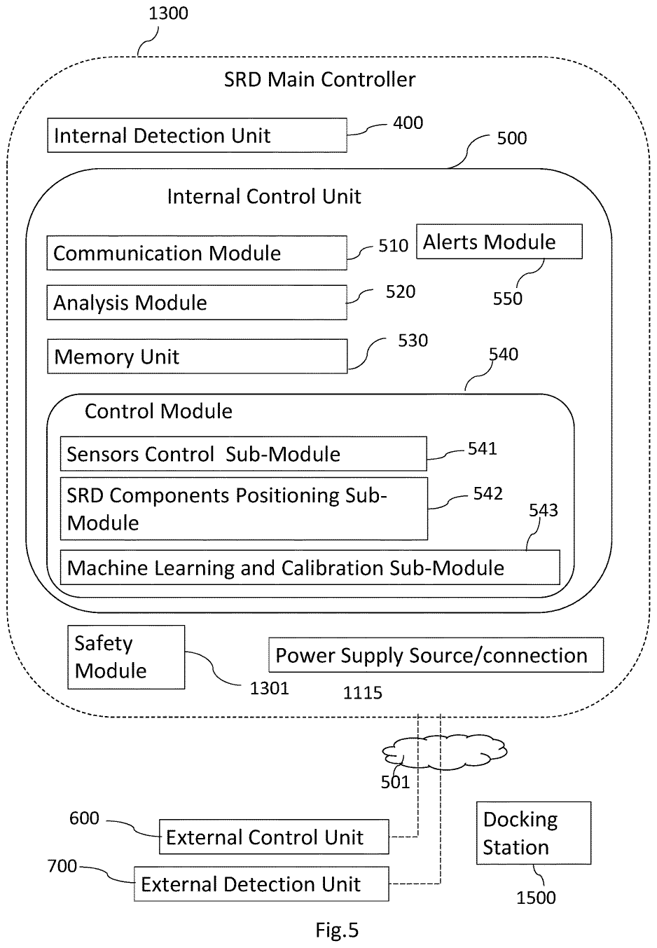

According to some embodiments, the SRD 1100 may include (see FIGS. 2A-2B):
three suspension cables 1101, 1102 and 1103, each suspension cable 1101/1102/1103 being respectively releasably and fixedly connectable at a distal side thereof, to a corresponding anchoring point 1001a/1102a/1103a located at a corresponding support wall Nov. 12, 2013, e.g., of a room 10;
a robot body 1110;
three length adjustment (LA) subsystems such as LA subsystem 1120 including a reel setup that includes a reel 1122 over which a proximal side of a respective suspension cable 1103 is wrapped, and a LA motor 1121 configured and positioned for rotating the reel 1122 thereby controlling overall length L of a stretched (unfurled) part of the respective suspension cable 1103;
three displacement subsystems, such as displacement subsystem 1130, which may include: a movable element such as a slidable element 1131, one or more tracks such as rod tracks 1132a and 1132b (over which the slidable element 1131 is slid), a cable guiding element (CGE) such as a pulley 1133 with which a respective suspension cable 1103 engages, a base 1134, a displacement (Dis.) motor 1135 and a drive shaft 1136 that is rotatable by the Dis. motor 1135;
at least one braking mechanism 1140 per each LA and/or displacement subsystem (see FIG. 3), configured for stopping the respective suspension cable from further loosening and being unwind by the respective reel 1122 and rotating of the pulley 1133 (from being pulled downwards due to the gravitational force constantly applied thereover) e.g., by locking the cable to a desired state defined by an overall length of a stretched part of the respective suspension cable 1103 (herein “stretched cable-part”) and ratio between two parts of the stretched cable-part, and are formed by the positioning of the pulley 1133 (see part L2 and part L1 of suspension cable 1103 in FIG. 3) such the overall length “L” of the stretched cable-part is L=L2+L1;
a control subsystem including one or more control units such as external control unit 600 and/or one or more internal SRD control unit such as SRD internal control unit 500;
a manipulation subsystem 1150 including one or more end effectors such as a gripper 1155 end effector; and
a detection subsystem including the external detection unit 700 and/or one or more internal detection units such as internal detection unit 400 (see FIG. 5) each detection unit including one or more sensors embedded therein and/or attached thereto, such as one or more cameras 401, 402 (see FIG. 2B), one or more other sensors such as a spectrometer, a gyroscope and/or accelerometer, a proximity sensor etc.

According to some embodiments, as shown in FIGS. 2A-3, each manipulation subsystem 1150 may include one or more grippers such as gripper 1155 that is configured as a tongs, clip or pincer device with two gripper-arms 1155a and 1155b that can controllably open and close for releasably grabbing of objects and for controlling other operations of the gripper 1155 such as for pushing against the object, firmly and/or loosely grabbing of the object, hanging the object and/or suspending the object in the air, spreading/stretching the object, shaking the object, and the like.

According to some embodiments, as shown in FIGS. 2A and 3, the SRD body 1110 may include slits or openings such as slit 1111, for each LA and/or for each displacement subsystem, from which a suspension cable 1101/1102/1103 can be threaded or pass.

According to some embodiments, the internal detection subsystem 400 of the SRD 1100 may also include one or more sensors such as operation-sensors 403-405 located at the manipulation subsystem 1150 for sensing end effector(s) related properties (herein end effector properties) and/or environment properties such as for sensing gripping state of the one or more gripper end effectors such as gripper 1155 and/or for sensing properties of the object to be handled by the respective end effector(s). For example, an inner side of each gripper-arm 1155a/1155b may have one or more proximity, touch, tactile and/or pressure sensors such as proximity sensors 403 and 404, where an opposite arm side of lower gripper-arm 1155b may also include a proximity, pressure and/or touch sensor 405 e.g., for sensing touch with a lower platform over which an object to be lifted is located.

According to some embodiments, as shown in FIG. 2B, the SRD body 1100 may also include a rotatable plate 1115 over which one or more sensors such as camera 450 may be attached for enabling controllable camera 450 positioning by rotating of the rotatable plate 1115, for enabling surround/panoramic viewing of the external surrounding area of the SRD 1100.

According to some embodiments the operation-sensors may be positioned and configured to measure and/or enable determining gripper properties such as: gripper position in the internal and/or external 3D coordinate system; one or more gripping strength properties of the gripper; relative position between the gripper and the object or a part thereof, etc.

Additionally or alternatively, one or more of the one or more grippers of the manipulation subsystem 1150 may include a controllable robotic arm that also has controllable gripper(s) end effectors.

According to some embodiments, the manipulation subsystem 1150 may include one or more serial arm manipulators as end effectors/grippers.

According to some embodiments, the manipulation subsystem 1150 may further include a rotatable platform 1152 rotatable by a rotation-motor 1151 connected to the rotatable platform 1152, where the gripper 1155 may be fixedly connected to the rotatable platform 1152, for rotating of the gripper 1155 about a rotation axis such as around a rotation axis that is parallel to the z′ axis of the internal x′y′z′ 3D coordinate system. According to some embodiments, the gripper 1155 may be also displaced over a 2D plane by the rotation of the rotation-motor 1151, if the gripper 1155 is not attached to a center of the platform 1152 or any other location that is aligned with rotation axis of the platform 1152, over a plane that is perpendicular to rotation axis of the platform 1152. In this configuration, the rotation of the rotatable platform 1152 may also be used to controllably adjust/stabilize the positioning of the gripper, in respect to the z′ axis of the internal x′y′z′ coordinate system.

According to some embodiments, as can be deduced from the design shown in FIGS. 2A-3, the drive shaft 1136 and the slidable element 1131 may be releasably and/or movably connectable to one another via any connection such as via a linear drive system/apparatus/installation, such that when the drive shaft 1136 is rotated to one rotational direction (in respect to the internal x′y′z′ coordinate system such as clockwise around a rotational axis that is parallel to the internal z′ axis) the slidable element 1131 will slide along the tracks 1132a and 1132b and drive shaft 1136, towards a first direction (e.g. towards the base 1134), and vice versa: when the drive shaft 1136 is rotated to an opposite rotational direction (in respect to the internal x′y′z′ coordinate system such as counterclockwise around the rotational axis that is parallel to the internal z′ axis) the slidable element 1131 will slide along the tracks 1132a and 1132b towards an opposite second direction (e.g. away from the base 1134). In this way, a rotational movement of the drive shaft 1136 (rotatable by the Dis. Motor 1135) is translated into linear movement of the slidable element 1131.

According to some embodiments, as shown in FIGS. 2A-2B, the slidable element 1131 is threaded through openings thereof through the two rod tracks 1132a and 1132b, which may only serve as guiding rods for stabilizing the linear movement of the slidable element 1131.

The linear movement of the slidable element 1131 along the internal z′ axis, causes linear displacement (in the internal coordinate system x′y′z′) of the pulley 1133 and therefore 3D linear displacement of a 3D point X1Y1Z1 from which an “extending part” of the respective suspension cable 1103 is stretched between the pulley 1133 and the fixture point 1103a at the support wall 13.

A first cable-section of an overall stretched part of the suspension cable 1103, which is not wrapped over the reel 1122, extends from the support wall 13 to the pulley 1133 is of length L1, and another, second cable-section of the stretched part of the suspension cable 1103, extending from the pulley 1133 to the reel 1122 (see FIG. 2B and FIG. 3) is of length L2. The first and second cable-sections form therebetween a non-zero “a” angle, where the overall length of the entire stretched cable-part is the summation of the first and second lengths, such that: L=L2+L1. The 3D positioning of the pulley 1133 (linearly displaceable by the corresponding displacement subsystem 1130) actually determines the length value of L1 and L2 and therefore the ratio therebetween L1:L2 and the value of angle “a”, where the overall 3D positioning of each of the pulleys 1133 of the three displacement subsystems 1130 of the SRD 1100 also move each cable's exit point from which it extends towards its anchoring point, ultimately for determining/controlling thereby the 3D positioning and orientation of the SRD body 1110.

According to some embodiments, the per-cable controllable displacement of the 3D point in the internal coordinate system x′y′z′ from which the first part of the cable extends from the corresponding pulley 1133 towards the corresponding support wall (herein the “extension point”), enables adjusting/controlling of the orientation (pitch and/or roll) of the SRD 1100 body 1110 in the external xyz 3D coordinate system and may be used for refining/correcting/improving the control of the robotic system 1000 over the positioning (position and orientation) and/or force applied by the body of the SRD 1100, over an object being intendent to handle.

Embodiments of the SRD 1100 are designed to enable a wide angle of movement of the SRD 1100 and/or of it one or more end effectors/grippers 1155, inter alia, for enabling the SRD 1100 to easily adapt its movement and manipulation abilities to a wide diversity of working environments of different working spaces, installation limitations, different working locations/stations, etc.

According to some embodiments, the displacement of the extension point may also enable improved control over the tension applied to and/or by the respective suspension cable.

FIG. 3 shows one example of a braking mechanism 1140 location and configuration. According to this example, the braking mechanism 1140 may include a braking element such as a braking-element 1141 which may be positioned adjacent or coupled to the pulley 1133 of the slidable element 1131 of the displacement subsystem 1130. The braking-element 1141 may be made of a high-friction material such as rubber for preventing the cable 1103 from changing length of its stretched part by clutching the brake-element 1141 to the pulley 1133 holding a small section of the cable 1103 therebetween. At least one additional motor and/or actuation means may be used for controlling engagement of the break element 1141 with the cable 1103 and pulley 1133.

According to some embodiments, once the sliding element 1131 reaches upper and/or lower dead-stops (e.g., by reaching the upper and lower plate/platform 1115/1152) it will passively limit the fall/lift of the SRD body 1110.

According to other embodiments, the braking mechanism may include one or more passive brake elements.

According to some embodiments, in which the robotic system does not include a displacement subsystem, the one or more braking elements may be attachable to the LA subsystem(s) of the RS.

According to some embodiments, the RS 1000 may be configured to control the length of the suspension cables 1001/1102/1103 of the SRD 1100 and/or displacement of the extraction points e.g., for controlling forces applied to the object being handled, by controlling tension in each suspension cable. For example, the robotic system 1100 may control speed at which the SRD 1100 is being lowered along the Z axis parallel to the gravitation direction, by controlling release and locking of its break elements 1141 for using gravity in applying force over the object to be handled thereby and/or by enabling swinging of the SRD body 1110 back and forth for spreading/ironing/flattening/unfolding of objects, etc.

According to some embodiments, devices of the RS 1000 and/or of the SRD 1100 such as sensors and motors of the RS 1000 may use one or more power sources for operation thereof.

For example, the SRD 1100 may include one power source such as rechargeable and/or replaceable/removable battery. In some cases, some of the motors and/or sensors etc., may use their own power supply source that can be either replaced and/or recharged.

According to some embodiments, the robotic system 1000 may further include a docking station such as docking station 1500 (FIG. 1), for enabling docking (e.g., by hanging) the SRD 1100 therein/thereover/thereby. The docking station 1500 may also be connected to an electricity supply line for enabling charging one or more batteries of the SRD 1100 when docked in the docking station 1500.

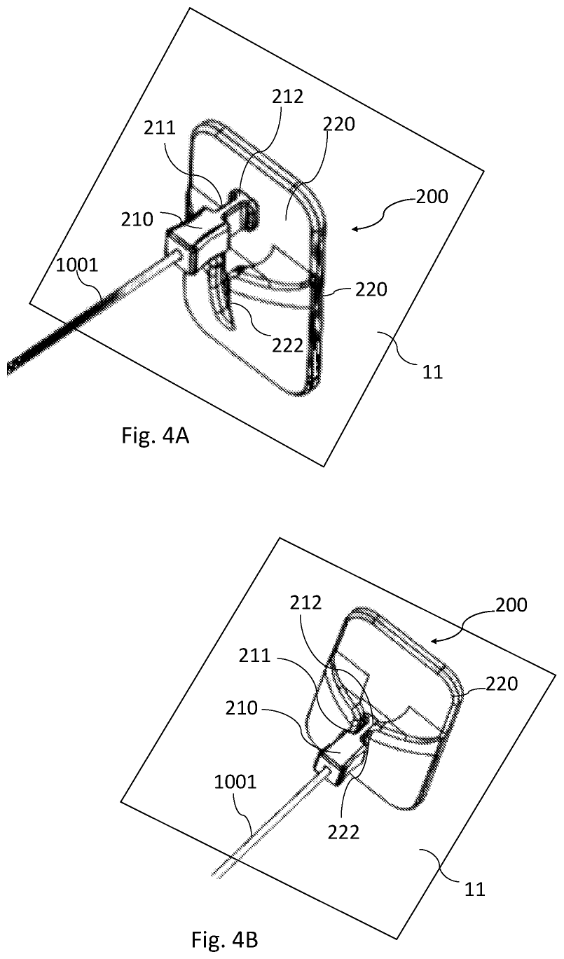

Reference is now made to FIGS. 4A-4B showing an anchoring device 200 for releasably fixating a suspension cable's 1101 distal edge to a corresponding support such as to a support wall 11 by using interlocking parts, according to some embodiments.

The anchoring device 200 may be mainly designed for supporting weight of the SRD body 1110 and all components thereof.

The anchoring device 200 may include: a first member 210 fixedly attached to a distal edge of the corresponding suspension cable 1101 and a second member 220 fixedly attachable to the support wall 11. The first member 210 may be designed such that it has a free edge part 212 that protrudes from a narrower second part 211 of the first member 210 and the second member 220 includes a corresponding indentation 222 that is designed to receive and hold therein part of the first member 210 such that its protruding first part 212 is also wider/larger than a part of the indentation 222 of the second member 220, allowing easy insertion and removal of the protruding part 212 by the narrower second part 211. In this way, the cable 1101 can be hung over the second member 220 by interlocking the edge of the first member 210 with the indentation 222 of the second member 220, in a releasable manner.

According to other embodiments, the SRD 1100 may be attached to the one or more support structures via a fixed anchoring such as by way of using an anchoring device that is fixedly (non-removably) connected to the distal edge of a respective cable 1101/1102/1103 and is fixedly connectable to the support such as by way of screwing the anchoring device to the wall Nov. 12, 2013.

Reference is now made to FIG. 5, showing a block diagram, schematically illustrating main modules and/or units of a main controller 1300 of the RS 1000, for receiving and processing of sensor data and controlling of the SRD 1100 and/or of the sensors positioning and/or operation, based on the results of the processed data and optionally also based on embedded actions plans/commands, according to some embodiments.

According to these embodiments, the main controller 1300 may include, for example:
(i) an internal detection unit 400 including/using various multiple sensors for sensing various internal SRD properties and/or external environmental properties such as one or more: optical sensors such as cameras, proximity sensor, pressure sensors, tactile sensor(s), pressure sensor(s), etc. for sensing SRD positioning in the external coordinate system xyz, positioning and/or state of its one or more end effectors, environmental properties such as positioning, state and/or any other object-properties of one or more objects in a nearby area of the SRD 1100, etc.;
(ii) an internal control unit 500; and
(optionally) an internal power supply source such as an internal battery pack 1107.

According to some embodiments, the internal control unit 500 may be configured to enable communication with one or more external devices such as with the external detection unit 700 and with the external control unit 600 if such are used by the robotic system 1000.

According to some embodiments, the internal control unit 500 may include one or more of:
a communication module 510, configured to receive in real time and/or near real time updated data including at least updated sensor data from internally and/or externally located sensors of the internal detection unit 400 (including the operation-sensors) and/or from the external detection unit 700 and optionally also for communicating with the external control unit 600;
an analysis module 520 configured to analyze received updated sensor data and determine, based on updated sensor data analysis results, how the SRD 1100 and/or one or more components of the SRD 1100 is/are to be controlled e.g., by determining location, positioning, orientation and/or functionality of the SRD 1100 and/or one or more components of the SRD 1100;
a memory unit 530 including one or more data storage units such as one or more databases for storing therein one or more of: accumulated sensor data and/or analysis results, action commands/plans/instructions for operation of the SRD 1100 and or one or more components thereof, sensors data, known objects' properties, one or more SRD operation programs, each operation program being associated with a different operation-category and may include multiple operation plans associated with the same operation programs, and the like;
a control module 540 generally configured to control any one or more
components of the SRD 1100, e.g., based on a retrieved operation plan (corresponding to a required operation of the SRD) and/or based on analysis of updated sensor data for having the SRD 1100 perform one or more process-sessions that are required by it such as for performing and completing a folding session.

According to some embodiments, the analysis module 520 may use one or more computer vision (CV) and/or digital signal processing (DSP) algorithms/modules.

According to some embodiments, as shown in FIG. 5, the control module 540 may be configured mainly for controlling the different SRD controllable components based on sensor data analysis and retrieved operation plan/instructions/commands. The control module 540 may include the following sub-modules:
a sensor-control sub-module 541 for controlling operation of the internal and/or of the external sensors of the detection subsystem for example for controlling camera mode/zoom and camera positioning (such as line of sight, field of view etc. of each camera) activation and deactivation of sensors and the like;
a SRD components positioning sub-module 542, configured for controlling positioning of each of the controllable components of the SRD such as the positioning of the SRD body 1110, the gripper(s)′ state/properties, displacement properties and control of the points from which each cable extends towards its corresponding support, etc.; and
(optionally) a machine learning and calibration sub-module 543 including for example one or more Machine Learning (ML) and/or artificial intelligence (AI) algorithms/models/programs for analysis of accumulated sensor data and adjusting/calibrating analysis programs designed for the ongoing analysis of updated sensor data and/or for adjusting/correcting/calibration of the one or more operation programs and plans used for ongoing operation of the RS/SRD 1000/1100.

According to some embodiments, communication between the SRD 1100 and the external units such as external control and/or detection units 600 and/or 700 may be done via one or more wired or wireless communication links and/or networks such as link 501.

According to some embodiments, the battery pack 1115 may include one or more batteries that may be replaceable and/or rechargeable.

Additionally or alternatively, the at least some of the system's components requiring power supply, may be connectable via one or more power cables/wires to a main external power supply such as to an electricity grid connection.

According to some embodiments, as shown in FIG. 5, the robotic system 1000 may also include a docking station 1500 attachable to a support structure such as to a wall 13 (see also in FIG. 1), where the docking station 1500 may be configured for holding thereover/thereby the SRD 1100 such as to enable easy and comfortable storage of the SRD 1100 (which may require releasing the cables 1101, 1102 and 1103 from the walls 11, 12 and 13).

According to some embodiments, the docking station 1500 may be electrically connectable to a power supply line and configured to enable docking of the SRD 1100 therein/thereover/thereby, such that when the SRD 1100 is docked it automatically connects to the power supply line for charging its battery(ies) 1115.

According to some embodiments, the main controller 1300 may further include a safety module 1301 configured to detect errors, malfunctioning and/or alarming situations based on analysis of received sensor data, using one or more safety algorithms, and send alarm messages and/or mitigate/correct detected malfunctions.

According to some embodiments, the internal or the external control units such as internal control unit 500 may further include an alerts module 550 for alerting one or more (human) using via one or more end devices thereof e.g., also including input and display means as well as a designated user interface, wherein alerts may be issued in the one or more of the following exemplary cases/scenarios: identified malfunctions of the RS; ready stacks of objects to be (manually) cleared from the stacking area, laundry folding schedules, etc. The user interface may also enable the user to adjustably schedule laundry folding sessions or other operations of the robotic system 1000.

According to some embodiments, the robotic system 1000 may use and/or include a designated application supported via one or more servers/processors, where the designated application may be installable and/or operable via one or more end devices used by one or more end users, such as various mobile devices such as mobile phone(s), tablet device(s), personal computer(s), etc. The designated application may be designed to support/operate a designated user interface enabling, for example, one or more of the following:
(i) enabling one or more users to schedule laundry folding operation sessions times/dates;
(ii) enabling one or more users to associate specific objects to specific entity/stack/stacking area;
(iii) enabling one or more users to set and/or adjust folding plans;
(iv) enabling one or more users to remotely control the SRD.

Aspects of disclosed embodiments pertain to a method for handling of one or more objects, the method comprising at least:
(i) providing a robotic system according to any one or more of claims 1 to 31;
(ii) receiving updated sensor data from one or more of the sensors of the robotic system;
(iii) analyzing the received updated sensor data to determine object properties of an object;
(iv) determining object properties of the respective object, based on analysis of the received updated sensor data;
(v) generating a customized manipulation plan for the respective object, based at least on determined object properties of the respective object;
(vi) manipulating the respective object by controlling one or more timed operations of the SRD of the robotic system, done by controlling operation of the at least one end effector, SRD body, SRD location and positioning and robotic system sensors based on the determined customized manipulation plan of the respective object.

According to some embodiments, the method may also include ongoing and/or a preliminary process of monitoring sensors and/or end effector(s) state(s) and adjusting sensor(s) and/or end effector(s) state based on analysis of received sensor data.

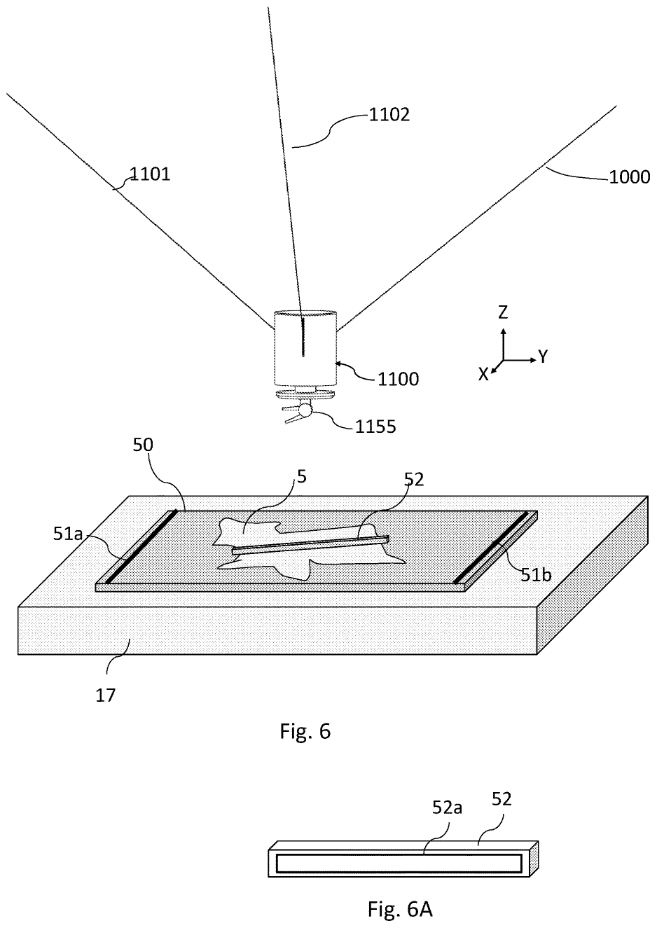

FIG. 6 shows how one or more auxiliary apparatuses (AAs) can be used for various purposes such as in assisting the process of objects folding, according to some embodiments. For example, a specially designed platform 50 may be used as one of the AAs, that is placeable over another surface such over a bed 17 or a table etc., over which each object to be folded may be placed such as T-shirt 5. The platform 50 may be a rigid object of known dimensions (e.g., of known width and length stored in a memory of the robotic system 1000) that enables identification/determination of dimensions of the object such as contour lines, length and width of the shirt 5 and/or parts thereof, that can be used for determination of object-properties of the corresponding object.

According to some embodiments, the platform 50 may also include one or more identification devices/markers attached thereto or embedded therein, such as one or more transmitters (such as RFID transmitters) and/or markers such as magnet and/or reflector markers 51a and 51b enabling sensors of the robotic system 1000 such as proximity sensor(s) or a magnetometer and/or optical sensor(s) of the robotic system 1000, to detect dimensions/position/location of the object (e.g. fabric/garment) 5 in respect to bordering lines of the platform 50 for further assisting in directing the gripper(s) 1155 of the SRD 1100 in a much more accurate manner in each of their operation action and therefore improve object folding accuracy, speed etc.

According to some embodiments, one or more additional mobile AAs may be used also for assisting the SRD 1100 in the actual folding of the garment 5 such as elongated AA 52. Any one or more of the AAs such as elongated AA 52 may include one or more markers such as scaling reference signs and/or a patterned design/sticker 52a printed/embossed/engraved/attached at least over one side thereof, such as seen in the zoomed in image of elongated AA 52 shown in FIG. 6A, for improving/optimizing precision in an image processing process for improving detection of one or more object-properties such as garment's: dimensions, size, color, bordering (contour) line, garment type and/or sub-type (clothing artifact, linen, etc., or subtypes such as shirt, trousers, sock, hat, blanket, etc.), garment's associated stack (a member of the family, general type such as linen, tablecloths etc.), fabric type, estimated elasticity level, and the like.

According to some embodiments, the elongated shape of the AA 52 may also be served for stretching/unfolding of the garment 5 prior to it being properly folded by the SR 1100, a part of a pre-folding preparation procedure, in which the garment 5 is unfolded from an unorganized state to an unfolded/stretched pre-folded state, by dragging the AA 52 when engaging the garment 5 back and forth along one or more axes. The AA 52 may further be used for the folding procedure itself by enabling positioning the AA 52 at a specific positioning over or under the garment 5 and using it as a blocking marker for folding one side of the garment 5 up until it reaches the line bordering the AA 52.

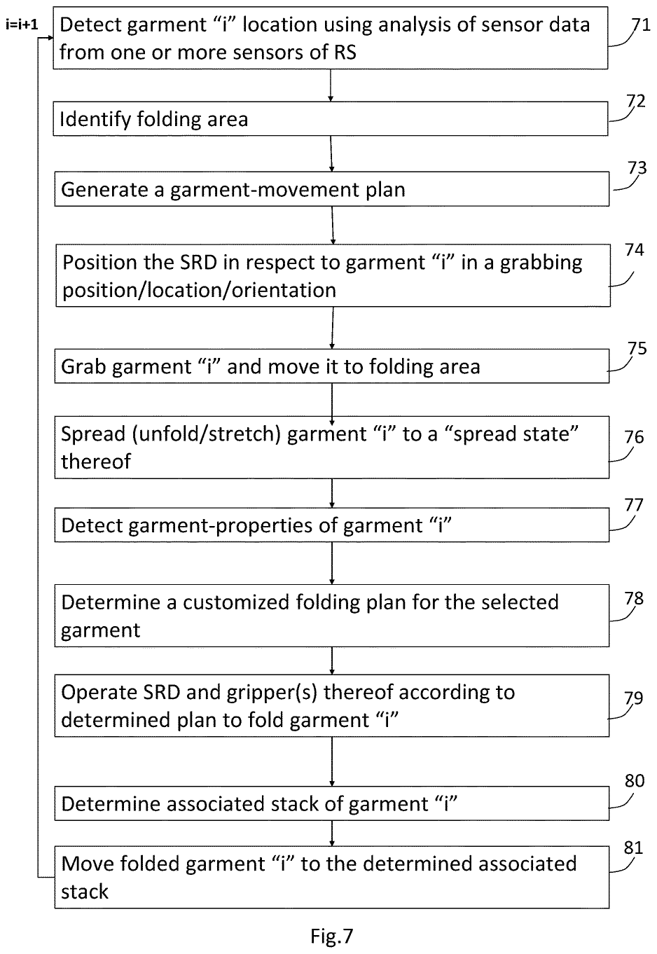

Reference is now made to FIG. 7, schematically illustrating a process of laundry folding of a pile of fabrics done automatically and autonomously by a SRD of a robotic system, according to some embodiments. According to these embodiments this process may include one or more of the following steps:
detecting/selecting a garment “i” (in a pre-handled pile of garments) to be currently folded by the SRD (step 71), using the one or more sensors of the detection subsystem;
identifying a folding area (step 72);
generating/retrieving a garment-movement plan including one or more SRD control commands/instructions etc., for moving the respective garment “i” to the identified folding area for folding thereof (step 73);
positioning the SRD in respect to the respective garment “i” for grabbing thereof (step 74);
grabbing the respective garment “i” and moving it to the identified folding area (Step 75);
spreading the respective garment “i” for preparing it for its organized folding by positioning the respective garment “i” in a “spread state” (step 76);
detecting one or more object-properties of the respective garment “i” (step 77) by using analysis of sensor data from the one or more sensors of the robotic system;
determining/retrieving a folding plan for the respective garment “i” including a set of folding commands for controlling the SRD (step 78);
operating the SRD according to the determined/retrieved folding plan (step 79) until the respective garment “i” is in a folded state;
determining a stack that is associated with the respective folded garment “i” (step 80); and
move the folded garment “i” to its associated stack (step 81).

Once the specific garment “i” is folded and placed in its associated stack, the next garment (i=i+1) may be folded by following the same steps of 71-81.

According to some embodiments, a specific stack location (e.g., also including a laundry capacitor such as a laundry drawer or basket), may be associated with each stack of garments for having each group of garments that are of a common category/type/sub-type be stacked together for easy later distribution of the laundry garments to their designated storage units such as designated drawer, cupboard/closet shelf etc.

According to some embodiments, measuring state of one or more of the robotic system sensors may be evaluated for determining whether the sensor(s) are in correct/desired positioning and functionality characteristics for measuring SRD and/or selected garment's properties such as location/position, garment-state and the like and adjust sensor state of each sensor that requires adjustment. The measuring state may include one or more of: sensor's field of view (FOV), sensor's focusing/zoom-in/out state, sensor's positioning (orientation), on/off state and the like. The sensor(s) state and/or adjustment may be done prior to and/or during the pre-folding process.

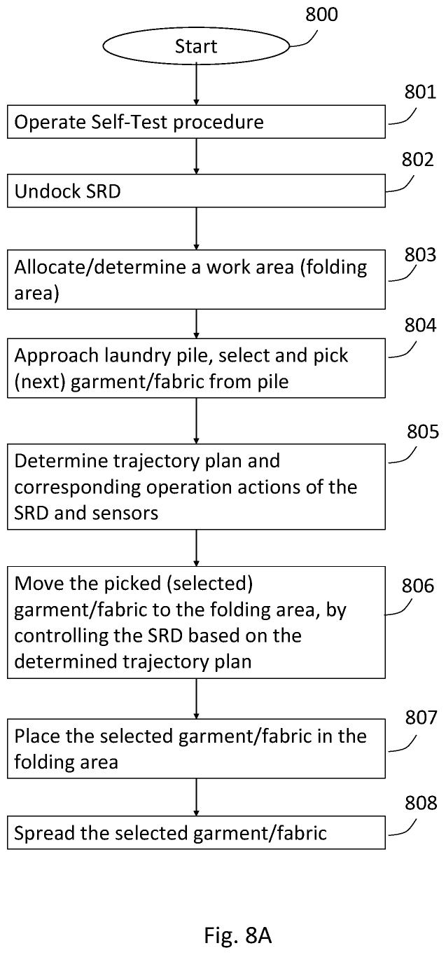

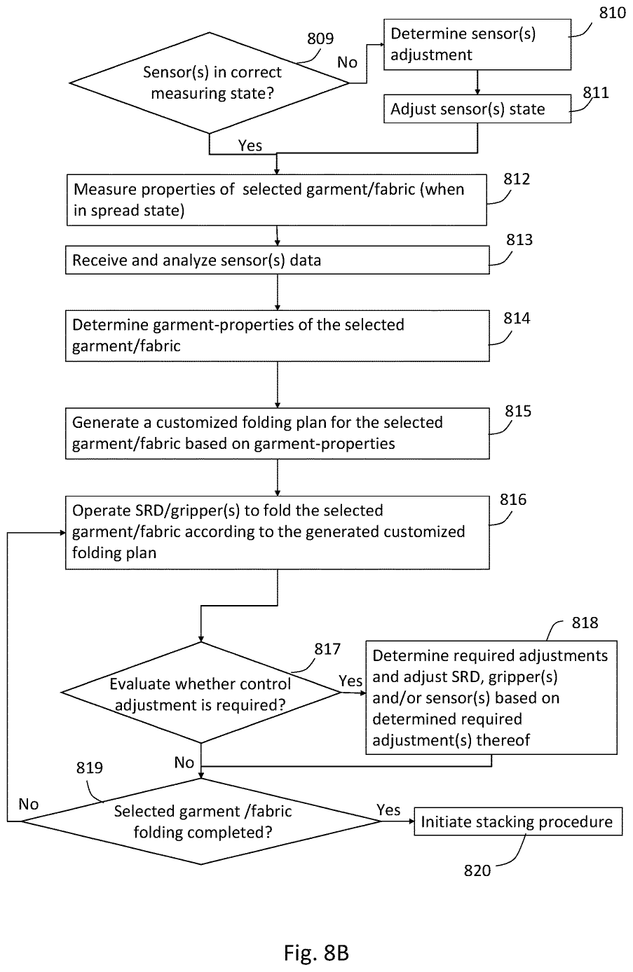

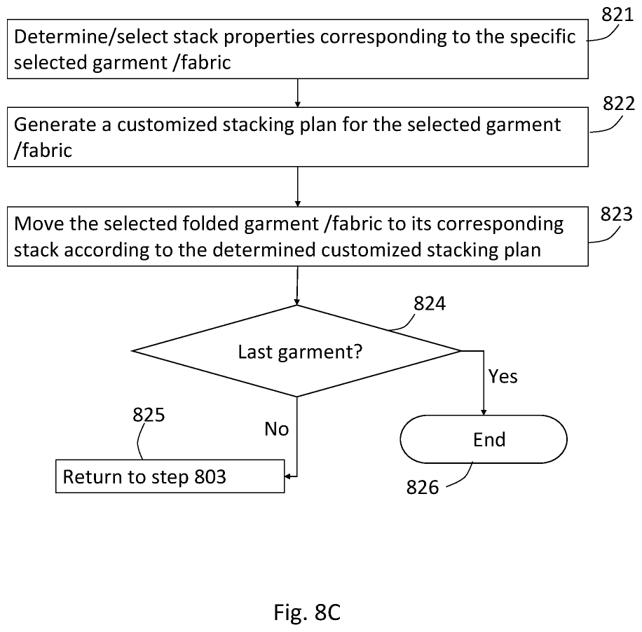

Reference is now made to FIGS. 8A-8C showing a flowchart of three main sequential processes of pre-folding (preparation), folding and stacking procedures performable per each garment (or any other type of foldable object) of a garments laundry pile, required for folding of each of these garments, where these processes use a robotic system with a SRD of some embodiments and customizes one or more of the control actions/plan of the robotic system or one or more components thereof, for each specific garment for measuring, folding and/or stacking of the specific garment. These steps 800-826 of FIGS. 8A-8C represent optional main required steps required for performing that laundry folding process which may be performed by the robotic system in an automatic/autonomous and customized manner and may include at least one of more of the following steps for each garment in the garments laundry pile: Garment pre-folding (garment preparation) procedure:

Once a laundry folding process/session is initiated (step 800), operate a self-testing procedure to verify that the robotic system and components thereof are in a proper functionality, location etc. for starting the folding process (step 801);
(optional) undocking the SRD of the robotic system (step 802) e.g., by starting (turning on) operation of the LA and/or Dis. motors and/or by automatically releasing the SRD from a docking station to which it is releasably attached;
allocating or determining a folding (work) area (step 803) in which the garments are to be separately placed and folded and optionally also stacked/folded garments' piles locations in relation to related-entities;
approaching the laundry pile, selecting and picking a next/first garment for folding thereof (herein “selected garment”) by controlling positioning and/or functionality of the SRD and gripper(s) thereof (step 804) (this step may further include an antecedent step of measuring/determining/estimating one or more properties of the laundry pile and one or more garments thereof for selecting the next garment to be folded, by analysis of received sensor data);
determining trajectory plan and corresponding SRD control operation instructions and/or actions (herein “movement plan”) for moving the selected garment to the folding area (step 805), e.g., based on measured/determined pile/garments properties;
moving the selected garment to the folding area, according to the determined trajectory plan and operation actions (step 806);
placing (by the SRD) of the selected garment in the folding area (step 807)
full or partial spreading (by the SRD) the selected garment (step 808) e.g., by using one or more AAs for stretching/unfolding of the selected garment over a flat or semi-flat part of the folding area.

The pre-folding procedure may include an ongoing or preceding monitoring and adjustment process of checking sensor properties of one or more of the sensors of the robotic system such as sensor(s) positioning (orientation and location), sensor(s) FOV, focusing properties etc., identifying for each sensor if one or more of its properties requires real time adjustment, and adjusting the respective sensor accordingly, for enabling ongoing suitable and correct measuring of the RS's functioning.

According to some embodiments, the pre-folding procedure may also include a pre-measuring step in which the location/area of the laundry pile is detected prior to the step of approaching the laundry pile (step 802), e.g., by using one or more sensors of the RS.

According to some embodiments, the spreading of the selected garment (step 808) may be carried out by first roughly unfolding the selected garment and then using the gripper(s) of the SRD and/or one or more AAs by bringing the gripper(s) or the AA grabbed thereby into contact with the selected garment and “ironing” (smoothing and/or pressing) it over the selected garment.

### Garment Folding Procedure:

Checking whether one or more of the robotic system sensors require adjustment (step 809);
determining adjustment required for the one or more sensors if adjustment is required (step 810), such as field of view (FOV), positioning, location, power supply, zooming level, focusing properties of optical sensors and the like;
adjusting the sensor(s) determined as requiring adjustment (step 811);
measuring the selected garment (Step 812) when in the spread state (whether fully or partially spread), using one or more sensors of the robotic system such as one or more optical sensors of the robotic system outputting updated sensor data;
receiving the measured updated sensor data (e.g., at a processor(s) of the robotic system and analyzing the received updated sensor data (step 813), using one or more processors and/or analysis modules of the robotic system 1000;
determining garment-properties of the selected garment such as, for example, garment's dimensions and/or size, garment type, related-entity, fabric type, garment's posture/positioning and/or contour lines/border, garment visual features, etc. (step 814);
generating a customized folding plan, customized for the specific selected garment, based on the determined garment-properties (step 815), e.g., by adjusting parameter values of a selected folding plan that is associated with the determined garment type according to garment's dimensions, positioning and contour line;
operating the SRD and/or gripper(s) thereof to fold the selected garment according to its generated folding plan (step 816);
monitoring (e.g., in real time or near real time) the execution of the actions of the folding plan and/or of the folding process (step 817) and evaluating whether control adjustment is required, e.g., for identification of folding-performances' impairments, by using data analysis of ongoing received sensor(s) data;
determining (e.g., in real time or near real time) required correction/mitigation of identified folding performances impairments e.g., by real time correction/adjustment of the customized folding plan and adjusting the customized folding plan based on determined required corrections/mitigation (step 818), e.g., by adjusting the gripper(s) trajectory plan and/or positioning;
once the folding of the selected garment is completed (step 819) the stacking procedure of the selected garment can be initiated (step 820) (if the folding procedure is not completed, returning to step 815).

The term “trajectory plan” may refer to a route along which the garment/object is to be moved for the handling/folding of the object/garment.

### Garment Stacking Procedure:

determining (e.g., by measuring or selecting) a corresponding stack for the specific selected (and folded) garment (step 821) e.g., based on the garment-properties of the selected garment;
generating a customized stacking plan for the selected garment (step 822) e.g., based on the determined corresponding stack and its associated garment-properties such as type, area/location size limitations, already existing garments in the corresponding stack, current height of the corresponding stack, requirement for a new stack associated with the same related entity or not, etc.
moving (by the SRD) the selected folded garment to the corresponding stack based on the generated customized stacking plan (step 823).

Once the selected garment is folded and stacked following the procedures illustrated in steps 804-823, and if the selected garment is not the last garment of the laundry pile (step 825), the robotic system may be configured to repeat the entire process of steps of 803-824 such that each garment of the laundry pile is prepared for folding, folded and stacked in a customized manner by returning to step 803.

### Object Manipulation Procedure:

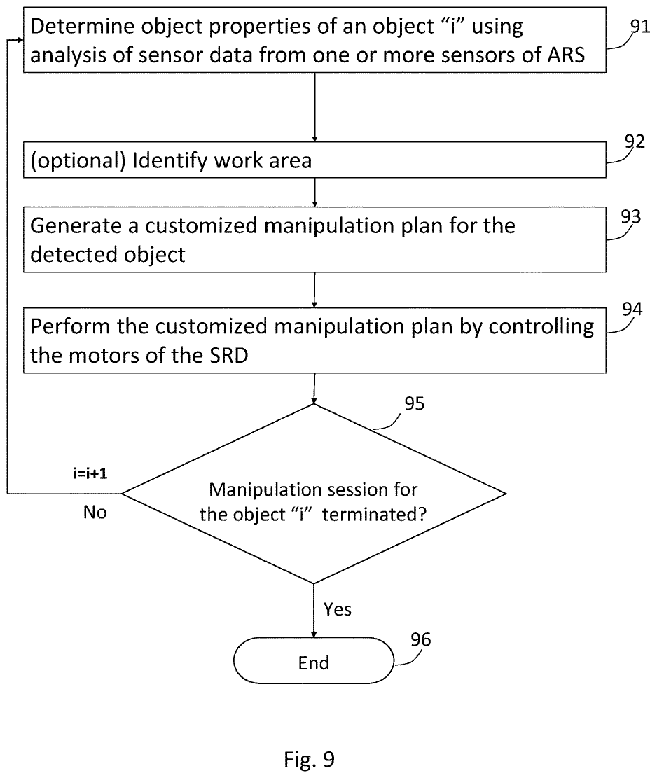

Reference is now made to FIG. 9, schematically illustrating a process of handling objects using a robotic system and a SRD thereof, according to some embodiments. This general process does not necessarily relate to laundry garments' folding but to any manipulation of any kind of object. This manipulation process may include at least the following main steps:
determining object-properties of a next/first object “i” to be manipulated (step 91) such as object's positioning (position and orientation), material, type, state, etc., e.g., by analyzing updated sensor data received from at least one sensor of the robotic system;
(optional) identifying work area in which the object is to be manipulated (step 92), which could be the actual current location of the object “i”;
generating a customized manipulation plan for the respective object “i” (Step 93) e.g., including moving the object “i” to the work area and/or manipulating of the object “i”;
perform one or more manipulations/operations over the object “i” according to the generated customized manipulation plan corresponding to the specific object “i”, by controlling the motors of the SRD (step 94);
if no more objects are to be manipulated in the current manipulation session (step 95) the manipulation session is terminated (step 96), if at least one other object is to be manipulated the steps 91-95 are repeated.

The term “manipulation” or any grammatical conjugation thereof used herein may refer to any operation done to any object such as folding of garment, sorting and/or displacing of items, connecting the object to another object/element, coating of the object, applying any type of energy such as heating and/or cooling of the object, and/or applying of mechanical forces to the object, welding of the object, adding/attaching/connecting other elements to the object, moving of the object or part(s) thereof, etc.

All manipulation actions/operations may be done by the SRD in a controllable manner and optionally also in an autonomous, semi-autonomous, automatic and/or semi-automatic manner.

According to some embodiments, the analysis of the updated sensor data of any one or more of the sensors of the robotic system may be done using one or more hardware and/or software means.

According to some embodiments, the analysis of received sensor data, especially sensor data arriving from one or more optical sensors of the robotic system, may include using one or more image-processing algorithms/programs, operable/implementable via one or more processing hardware and/or software means.

According to some embodiments, the control subsystem may be configured to accumulate results of analysis of the updated sensor data done for any purpose mentioned above, such as for the determination of object-properties, for generating of a manipulation/folding/movement/stacking plan etc. and/or the received updated sensor data, over time and to operate one or more Machine Learning (ML) and/or Artificial Intelligence (AI) algorithms and adjust analysis of received updated sensor data for improving robotic system and/or SRD control, improve customized plans generation and the like.

It is to be noted that, with reference to FIG. 5, some of the blocks can be integrated into a consolidated block or can be broken down to a few blocks and/or other blocks may be added. Furthermore, in some cases, the blocks can be performed in a different order than described herein. It is to be further noted that some of the blocks are optional. It should be also noted that whilst the flow diagram is described also with reference to the system elements that realizes them, this is by no means binding, and the blocks can be performed by elements other than those described herein.

It is to be noted that, with reference to any one or more of FIGS. 7, 8A-8C and/or 9, some of the steps in the flowcharts illustrated therein, can be integrated into a consolidated block/step or can be broken down to a few blocks/steps and/or other blocks/steps may be added. Furthermore, in some cases, the steps can be performed in a different order than described herein. It is to be further noted that some of the steps may be optional. It should be also noted that whilst the flow diagram is described also with reference to the system elements that realizes them, this is by no means binding, and the steps can be performed by elements other than those described herein.

### EXAMPLES

Example 1 is a robotic system (RS) for handling of objects, the robotic system comprising at least:
(i) a suspendable robotic device (SRD) comprising at least:
at least one suspension cable configured to be anchored, from a distal side thereof, to a support structure;
at least one length-adjustment (LA) subsystem comprising at least:
at least one reel, wherein each suspension cable is releasably wrapped, from a proximal side thereof, around the at least one reel of a corresponding LA subsystem; and
at least one LA motor, wherein each LA motor is operatively associated with a different corresponding at least one of a different LA subsystem, each LA motor being configured to controllably adjust length of a corresponding suspension cable of the SRD, by controllably rotating of the corresponding at least one reel of the corresponding LA subsystem, for controlling an overall positioning of the SRD in respect to a fixed external three-dimensional (3D) coordinate system; and
at least one displacement subsystem comprising at least one displacement (Dis.) motor positioned and configured to controllably and separately displace a 3D point in an internal 3D coordinate system of the SRD, from which a corresponding suspension cable extends towards its corresponding support structure;
a manipulation subsystem comprising at least one end effector and one or more operation motors configured at least for controlling state of the at least one end effector;
(ii) a detection subsystem comprising at least one sensor and configured to detect one or more properties of the SRD, one or more objects to be handled by the robotic system and/or surrounding environment of the robotic system; and
(iii) a control subsystem comprising one or more control units, at least one of the one or more control units being configured at least to:
receive and analyze sensor data arriving from the at least one sensor to determine one or more characteristics of the SRD and/or one or more objects in their surrounding environment; and
control at least the state of each of the at least one end effector of the manipulation subsystem, by controlling operation of motors of the LA subsystem, the displacement subsystem and the manipulation subsystem.

In example 2, the subject matter of example 1 may include, wherein each displacement subsystem comprises at least one cable guiding element (CGE), a moveable element in which the CGE is located, at least one drive shaft and at least one Dis. Motor, wherein the Dis. motor is configured to displace the position of the CGE in the internal 3D coordinate system of the SRD, for positioning of the SRD in the external coordinate system by rotating of the drive shaft and thereby displacing the point from which the corresponding suspension cable extends, wherein the moveable element is attached to the drive shaft such that when the corresponding Dis. Motor rotates the drive shaft to one rotation direction, the moveable element and CGE therein is displaced to a first direction and when the corresponding Dis. Motor rotates the drive shaft to an opposite rotation direction, the moveable element and CGE therein is displaced to an opposite second direction.

In example 3, the subject matter of example 2 may include, wherein part of the proximal side of the corresponding suspension cable is wrapped around the corresponding reel and another part of the corresponding suspension cable extends from the corresponding reel and passes through a corresponding CGE of the corresponding displacement subsystem.

In example 4, the subject matter of any one or more of examples 1 to 3, wherein the control subsystem is configured to analyze or process sensor data from the one or more sensors thereof to determine one or more of:
object properties of a corresponding object to be handled by the SRD;
surrounding environment properties;
SRD properties and/or state;
sensors properties and/or state;
end effector properties or state of each end effector of the SRD;
operation plan for handling of the respective object, based on determined object properties.

In example 5, the subject matter of any one or more of examples 1 to 4 may include, wherein at least one of the at least one sensor of the detection subsystem is embedded in or attached to the SRD.

In example 6, the subject matter of any one or more of examples 1 to 5 may include, wherein the at least one sensor comprises at least one of: at least one camera; at least one proximity sensor; at least one accelerometer; at least one thermometer; at least one acoustic transducer; at least one pressure sensor, at least one load and/or force sensor; at least one current sensor, at least one absolute and/or relative encoder, at least one gyroscope, at least one magnetometer.

In example 7, the subject matter of any one or more of examples 1 to 6 may include, wherein the detection subsystem comprises at least one pattern projector, configured to project light in one or more patterns onto the object or part thereof, for assisting in detection of one or more object properties of the respective object.

In example 8, the subject matter of any one or more of examples 1 to 7 may include, wherein the at least one end effector comprises one or more of: a gripper, a robotic arm, a hardware tool, a connector, a coating device, an ironing device, a screw driver, a drilling device.

In example 9, the subject matter of any one or more of examples 1 to 8 may include, wherein the at least one detection subsystem further comprises one or more operation-sensors configured to sense one or more properties of each of the at least one end effectors and/or of the object, and wherein at least one of the one or more control units of the control subsystem is configured to receive and analyze updated sensor data arriving from the at least one operation-sensor and control the SRD and/or the at least one end effector, also based on analysis of the updated sensor data from the at least one operation-sensor.

In example 10, the subject matter of example 9 may include, wherein the one or more operation-sensors comprise one or more of: a touch sensor, a tactile sensor, a proximity sensor, a gyroscope, a magnetometer, an accelerometer, an optical sensor, an acoustic transducer, a pressure sensor, a positioning sensor or system, an orientation sensor.

In example 11, the subject matter of any one or more of examples 9 to 10 may include, wherein the at least one operation-sensor is configured to enable determining one or more of:
end effector position and/or orientation in the internal and/or external 3D coordinate system;
one or more applied-force properties of the end effector;
relative position between the end effector and the object or a part thereof;
one or more object properties of the object.

In example 12, the subject matter of any one or more of examples 9 to 11 may include, wherein the at least one operation-sensor is further configured to transmit updated sensor data associated with the at least one end effector, to the control subsystem, which is further configured to receive and analyze end effector related updated sensor data to determine, based on received updated sensor data from the at least one operation-sensor, the one or more properties of the object and/or of the at least one end effector.

In example 13, the subject matter of any one or more of examples 1 to 12 may include, wherein at least one of the one or more control units comprises at least one of: at least one processor, at least one database or data storage unit, an analysis module, a control module.

In example 14, the subject matter of any one or more of examples 1 to 13 may include, wherein the control subsystem comprises a single control unit embedded in the SRD.

In example 15, the subject matter of any one or more of examples 1 to 13 may include, wherein the control subsystem comprises several control units at least one of which being embedded in the SRD and at least another of which being located externally to the SRD.

In example 16, the subject matter of any one or more of examples 1 to 15 may include, wherein at least one sensor of the detection subsystem is embedded in the SRD.

In example 17, the subject matter of any one or more of examples 1 to 15 may include, wherein at least one detection subsystem of the robotic system is embedded in the SRD and at least another detection subsystem of the robotic system is located externally to the SRD.

In example 18, the subject matter of any one or more of examples 1 to 17 may include, wherein the control subsystem comprises a safety module configured to detect alarming situations based on analysis of received sensor data, using one or more safety algorithms.

In example 19, the subject matter of any one or more of examples 1 to 18 may include, wherein the at least one control subsystem is configured to accumulate or store sensor data and/or analysis thereof and to use one or more Machine Learning (ML) and/or Artificial Intelligence-based (AI) algorithms to adjust sensor data analysis methodic and/or motors control performances.

In example 20, the subject matter of any one or more of examples 1 to 19 may include, wherein the control subsystem is configured for monitoring sensing and/or object-handling processes and/or performances based on analysis of sensor data.

In example 21, the subject matter of example 20 may include, wherein the control subsystem is configured to determine sensor state of at least one sensor of the detection subsystem and adjust state of the respective sensor accordingly.

In example 22, the subject matter of example 21 may include, wherein the state of a sensor comprises one or more of: sensor positioning; sensor resolution; sensor zooming properties; sensor mode; sensor operation state; sensor field of view (FOV); sensor focusing properties; sensor sensitivity properties.

In example 23, the subject matter of any one or more of examples 1 to 22 may include, wherein the robotic system further comprises at least one braking mechanism for each suspension cable of the SRD, each braking mechanism being configured for passive or controllable active preventing of the respective suspension cable from continuing to be released.

In example 24, the subject matter of example 23 may include, wherein the braking mechanism comprises at least one braking element having a high-friction material that can be engaged with the suspension cable for braking a releasing thereof.

In example 25, the subject matter of any one or more of examples 1 to 24 may include, wherein the robotic system is configured for folding of garments of a laundry pile, and wherein the at least one detection subsystem is configured to measure one or more properties of each garment selected to be folded and at least one of the one or more controls units is configured to determine one or more object-properties of the selected garment, based on measured one or more properties of the selected garment, and control the motors of the LA subsystem, the displacement subsystem and/or of the manipulation subsystem for folding of each selected garment to be folded.

In example 26, the subject matter of example 25 may include, wherein the one or more object-properties comprise one or more of: garment positioning; garment type identification; garment dimensions; garment proportions; garment fabric type; garment state; garment visual features; garment related-entity.

In example 27, the subject matter of any one or more of examples 25 to 26 may include, wherein the at least one control unit is configured, for each selected garment, to generate a customized folding plan corresponding to the specific selected garment, based at least on the determined garment properties of the selected garment.

In example 28, the subject matter of any one or more of examples 25 to 27 may include, wherein the robotic system is configured to use one or more auxiliary apparatuses for improving accuracy in measuring and/or determining of properties of the garments and/or of the robotic system and/or for assisting the SRD in performing actual folding of at least one of the garments.

In example 29, the subject matter of any one or more of examples 25 to 28 may include, wherein the robotic system is further configured to fold each garment by:
performing a pre-folding procedure requiring execution of one or more pre-folding actions to each selected garment to be folded based on detected object-properties and measured properties of the SRD and/or its surrounding environment;
performing a folding procedure comprising at least: generating a customized folding plan, customized for the specific selected garment, wherein the customized folding plan comprises one or more executable folding actions for controlling of one or more of the motors of the LA subsystem, the displacement subsystem and/or the manipulation subsystem; and
performing a stacking procedure comprising one or more executable stacking actions of controlling one or more of the motors of the LA subsystem, the displacement subsystem and/or the manipulation subsystem, for stacking each selected garment after it was folded.

In example 30, the subject matter of example 29 may include, wherein the pre-folding procedure comprises one or more of the following steps:
determining a folding area in which the garments of a laundry pile are to be placed and folded;
selecting a next/first garment for folding thereof;
determining trajectory plan and corresponding SRD control operation instructions and/or actions for moving the selected garment to the folding area;
moving the selected garment to the folding area, according to the determined trajectory plan and corresponding SRD control operation actions;
placing the selected garment in the folding area;
spreading the selected garment to a spread state.

In example 31, the subject matter of example 30 may include, wherein the selecting of a next garment step further includes measuring object-properties of one or more garments in the laundry pile before selecting of the next garment, and selecting the next garment, based on measured garment properties.

In example 32, the subject matter of any one or more of examples 29 to 31 may include, wherein the pre-folding procedure comprises a pre-measuring step in which the laundry pile location is detected.

In example 33, the subject matter of any one or more of examples 30 to 32 may include, wherein the pre-folding procedure further comprises measuring one or more object-properties of each selected garment, using the at least one detection subsystem.

In example 34, the subject matter of any one or more of examples 29 to 33 may include, wherein the folding procedure comprises one or more of the following steps:
measuring the selected garment when in a spread state producing updated sensor data associated with the selected garment, using the at least one detection subsystem;
receiving and analyzing the updated sensor data from the at least one detection subsystem, by the control subsystem;
determining object-properties of the selected garment, based on analysis of the received updated sensor data;
generating a customized folding plan, customized for the specific selected garment, based on the determined object-properties;
operating the SRD and/or the at least one end-effector of the SRD, for folding of the selected garment, according to the generated folding plan of the selected garment.

In example 35, the subject matter of example 34 may include, wherein the folding procedure further comprises:
monitoring in real time or near real time execution of folding actions of the folding plan and/or of the folding process, for identification of folding-performances' impairments; and
determining, in real time or near real time, required mitigation of identified folding performances impairments;
performing the determined required mitigation by the SRD.

In example 36, the subject matter of any one or more of examples 34 to 35 may include, wherein the stacking procedure comprises one or more of the following steps:
determining a corresponding stack for the specific folded selected garment, based on one or more of determined object-properties of the selected garment;
generating a customized stacking plan for the selected garment, based on the determined corresponding stack and its associated properties; and
moving the selected garment to the corresponding stack based on the generated customized stacking plan.

In example 37, the subject matter of any one or more of examples 1 to 36 may include, wherein the SRD body further comprises at least one rotatable plate and at least one rotation motor for rotating of the rotatable plate.

In example 38, the subject matter of example 37 may include, wherein the at least one rotatable plate is configured to:
connect to the at least one end effector and rotate thereof; and/or
connect to at least one sensor and enable controlling position of the at least one sensor connected thereto, by rotating thereof.

In example 39, the subject matter of any one or more of examples 1 to 38 may include, wherein the robotic system further comprises a docking station for releasable docking of the SRD thereover or thereby.

Example 40 is a method for handling of one or more objects, the method comprising at least:
(i) providing a robotic system according to any one or more of claims 1 to 39;
(ii) receiving updated sensor data from one or more of the sensors of the robotic system;
(iii) analyzing the received updated sensor data to determine object properties of an object;
(iv) determining object properties of the respective object, based on analysis of the received updated sensor data;
(v) generating a customized manipulation plan for the respective object, based at least on determined object properties of the respective object;
(vi) manipulating the respective object by controlling one or more timed operations of the SRD of the robotic system, done by controlling operation of at least one of: operation and state of the at least one end effector of the SRD, positioning of the SRD body, based on the determined customized manipulation plan of the respective object.

In example 41, the subject matter of example 40 may include, wherein the manipulation of the one or more objects is associated with one of: sorting of objects, folding of objects, connecting an object to another object or element, coating of objects, heating of objects, moving an object to a specific position, illuminating of object and/or an area, sensing of objects.

Example 42 is a method for folding garments of a laundry garments pile, the method comprising at least:
(a) providing a robotic system (RS) that comprises at least a suspendable robotic device (SRD) comprising at least one end effector and configured to be suspended from one or more support structures by at least one suspension cable in a controllable manner such that a robot body of the SRD can be position-controlled by controlling at least overall length of the at least one suspension cable of the SRD; at least one detection unit using one or more sensors; and a control subsystem configured at least for controlling operation of the SRD;
(b) selecting a garment from the laundry pile to be folded by the SRD;
(c) detecting a folding area;
(d) moving the selected garment to the folding area by controllably using at least one end effector of the SRD;
(e) spreading the garment in the folding area, by controllably using at least one end effector of the SRD;
(f) measuring the selected garment, using at least one sensor of the at least one detection subsystem;
(g) analyzing the received updated sensor data by the control subsystem of the RS;
(h) determining one or more object-properties of the selected garment, based on analysis of the received updated sensor data;
(i) generating a customized folding plan for the selected garment, based on analysis of the object-properties of the selected garment;
(j) operating the SRD for folding of the selected garment, according to the generated customized folding plan, wherein the operation of the SRD is controlled by the control subsystem.

In example 43, the subject matter of example 42 may include, wherein the method further comprises determining a stack that is associated with the respective folded selected garment and moving the folded selected garment when in a folded state to the determined associated stack.

In example 43, the subject matter of any one or more of examples 42 to 43 may include, wherein each garment is folded by:
performing a pre-folding procedure requiring execution of one or more pre-folding actions to each garment to be folded based on detected object-properties and determined properties of the SRD and/or its surrounding environment, based on analysis of sensor data;
performing a folding procedure comprising at least: generating a customized folding plan, customized for the specific selected garment, wherein the customized folding plan comprises one or more executable folding actions for controlling of one or more of the motors of the SRD; and
performing a stacking procedure comprising one or more executable stacking actions by controlling of one or more of the motors of the SRD, for stacking each selected garment after it was folded.

In example 45, the subject matter of example 44 may include, wherein the pre-folding procedure comprises one or more of the following steps:
measuring one or more properties of the laundry pile and one or more garments thereof;
selecting a next garment to be folded, based on analysis of measured properties of the laundry pile;
determining a folding area in which the garments of a laundry pile are to be placed and folded;
determining trajectory plan and corresponding SRD control operation instructions and/or actions for moving the selected garment to the folding area;
moving the selected garment to the folding area, according to the determined trajectory plan and corresponding SRD control operation actions;
placing the selected garment in the folding area;
spreading the selected garment to a spread state.

In example 46, the subject matter of example 45 may include, wherein the pre-folding procedure involves ongoing or preceding monitoring and adjustment process of checking sensor properties of one or more of the at least one sensor of the robotic system, and adjusting the respective sensor accordingly, for enabling ongoing measuring impairments mitigation.

In example 47, the subject matter of any one or more of examples 44 to 46 may include, wherein the pre-folding procedure further comprises a pre-measuring step in which the laundry pile location is detected.

In example 48, the subject matter of any one or more of examples 44 to 47 may include, wherein the folding procedure comprises one or more of the following steps:
measuring the selected garment when in a spread state for producing updated sensor data associated with the selected garment, using the at least one detection subsystem;
receiving and analyzing the updated sensor data from the at least one detection subsystem, by the control subsystem;
determining object-properties of the selected garment, based on analysis of the received updated sensor data;
generating a customized folding plan, customized for the specific selected garment, based on the determined object-properties;
operating the SRD and/or the at least one gripper of the SRD, for folding of the selected garment, according to the generated folding plan of the selected garment.

In example 49, the subject matter of example 48 may include, wherein the folding procedure further comprises:
monitoring in real time or near real time execution of folding actions of the folding plan and/or of the folding process, for identification of folding-performances' impairments; and
determining, in real time or near real time, required mitigation of identified folding performances impairments;
performing the determined required mitigation by the SRD.

In example 50, the subject matter of any one or more of examples 44 to 49 may include, wherein the stacking procedure comprises one or more of the following steps:
determining a corresponding stack for the specific folded selected garment, based on one or more of determined object-properties of the selected garment;
generating a customized stacking plan for the selected garment, based on the determined corresponding stack and its associated properties; and
moving the selected garment to the corresponding stack based on the generated customized stacking plan.

In example 51, the subject matter of any one or more of examples 44 to 50 may include, wherein the SRD comprises at least one of each of the following:
at least one suspension cable configured to be anchored, from a distal side thereof, to a corresponding support structure;
at least one length-adjustment (LA) subsystem comprising at least:
at least one reel setup, each reel setup comprising at least one reel, wherein each suspension cable is releasably wrapped, from a proximal side thereof, around at least one of the at least one reel of a corresponding reel setup; and
at least one LA motor, wherein each LA motor is operatively associated with a different corresponding reel setup, each LA motor being configured to controllably adjust length of a different corresponding suspension cable, by controllably rotating of the corresponding at least one reel of the corresponding reel setup, for controlling an overall positioning of the SRD in respect to a fixed external three-dimensional (3D) coordinate system;
a manipulation subsystem comprising at least one gripper and one or more operation motors configured at least for controlling gripping state of the at least one gripper;
a detection subsystem comprising at least one sensor, the detection subsystem being configured to detect one or more properties of the SRD and its surrounding environment.

In example 52, the subject matter of example 51 may include, wherein the SRD further comprises an internal control unit configured at least to:
receive and analyze updated sensor data arriving from the at least one sensor of the detection subsystem to determine one or more characteristics of the SRD and/or its surrounding environment; and
control at least position and state of each of the at least one gripper by controlling motors of the LA subsystem, and the manipulation subsystem, based on analysis of the updated sensor data.

In example 53, the subject matter of any one or more of examples 51 to 52 may include, wherein the SRD further comprises at least one displacement subsystem configured to controllably and separately displace a 3D point in an internal 3D coordinate system of the SRD, from which the corresponding cable extends towards its corresponding support structure.

In example 54, the subject matter of example 53 may include, wherein the displacement subsystem comprises at least one of each of the following components: a CGE, a moveable element holding the CGE, a displacement motor (Dis. Motor) and a drive shaft rotatable by the Dis. Motor, wherein rotation of the drive shaft causes movement of the moveable element along a trajectory in an internal SRD coordinate system.

Example 55 is a robotic system (RS) for folding of garments of a laundry garments pile, the robotic system comprising at least:
(i) a suspendable robotic device (SRD) comprising at least:
at least one suspension cable configured to be anchored, from a distal side thereof, to a corresponding support structure;
at least one length-adjustment (LA) subsystem comprising at least:
at least one reel setup, each reel setup comprising at least one reel, wherein each suspension cable is releasably wrapped, from a proximal side thereof, around at least one of the at least one reel of a corresponding reel setup; and
at least one LA motor, wherein each LA motor is operatively associated with a different corresponding reel setup, each LA motor being configured to controllably adjust length of a different corresponding suspension cable of the SRD, by controllably rotating of the corresponding at least one reel of the corresponding reel setup, for controlling an overall positioning of the SRD in respect to a fixed external three-dimensional (3D) coordinate system; and
a manipulation subsystem comprising at least one gripper and one or more operation motors configured at least for controlling gripping state of the at least one gripper;
(ii) a detection subsystem comprising at least one sensor and is configured to detect one or more properties of the SRD and its surrounding environment; and
(iii) a control subsystem comprising one or more control units, at least one of the one or more control units being configured at least to:
receive and analyze sensor data arriving from the at least one sensor to determine one or more characteristics of the SRD and/or its surrounding environment; and
control at least position and state of each of the at least one gripper by controlling motors of the LA subsystem and the manipulation subsystem.

In example 56, the subject matter of example 55 may include, wherein the SRD further comprises at least one displacement subsystem controllable via the control subsystem, the at least one displacement subsystem being configured to controllably and separately displace a 3D point in an internal 3D coordinate system of the SRD, from which the corresponding suspension cable extends towards its corresponding support structure.

In example 57, the subject matter of example 56 may include, wherein the at least one displacement subsystem comprises at least one of each of the following components: a CGE, a moveable element holding the CGE, a displacement motor (Dis. Motor) and a drive shaft rotatable by the Dis. motor, wherein rotation of the drive shaft causes movement of the moveable element along a trajectory in an internal SRD coordinate system.

In example 58, the subject matter of example 57 may include, wherein part of the proximal side of the corresponding suspension cable is wrapped around the corresponding reel and another part of the corresponding suspension cable extends from the corresponding reel and passes through a corresponding CGE of the corresponding displacement subsystem, such that rotation of the reel by the LA motor, causes adjustment of an overall length L of a portion of the suspension cable that is being currently stretched.

In example 59, the subject matter of any one or more of examples 55 to 58 may include, wherein the one or more object-properties comprise one or more of: garment positioning; garment type identification; garment dimensions; garment proportions; garment fabric type; garment state; garment visual features; garment related-entity.

In example 60, the subject matter of any one or more of examples 55 to 59 may include, wherein the robotic system is configured to use one or more auxiliary apparatuses for improving accuracy in measuring and/or determining of properties of the garments and/or of the robotic system and/or for assisting the SRD in performing actual folding of at least one of the garments.

In example 61, the subject matter of any one or more of examples 55 to 60 may include, wherein the robotic system is further configured to fold each garment by:
performing a pre-folding procedure requiring execution of one or more pre-folding actions to each selected garment to be folded based on detected object-properties and measured properties of the SRD and/or its surrounding environment;
performing a folding procedure comprising at least: generating a customized folding plan, customized for the specific selected garment, wherein the customized folding plan comprises one or more executable folding actions for controlling of one or more of the motors of the LA subsystem, the displacement subsystem and/or the manipulation subsystem; and
performing a stacking procedure comprising one or more executable stacking actions of controlling of one or more of the motors of the LA subsystem, the displacement subsystem and/or the manipulation subsystem, for stacking each selected garment after it was folded.

In example 62, the subject matter of example 61 may include, wherein the pre-folding procedure comprises one or more of the following steps:
determining a folding area in which the garments of a laundry pile are to be placed and folded;
selecting a next/first garment for folding thereof;
determining trajectory plan and corresponding SRD control operation instructions and/or actions for moving the selected garment to the folding area;
moving the selected garment to the folding area, according to the determined trajectory plan and corresponding SRD control operation actions;
placing the selected garment in the folding area;
spreading the selected garment to a spread state.

In example 63, the subject matter of example 62 may include, wherein the pre-folding procedure comprises ongoing or preceding monitoring and adjustment process of checking sensor properties of one or more of the at least one sensor of the robotic system, and adjusting the respective sensor accordingly, for enabling ongoing measuring impairments mitigation.

In example 64, the subject matter of any one or more of examples 61 to 63 may include, wherein the pre-folding procedure comprises a pre-measuring step in which the laundry pile location is detected.

In example 65, the subject matter of any one or more of examples 61 to 64 may include, wherein the pre-folding procedure further comprises measuring one or more object-properties of each selected garment, using the at least one detection subsystem.

In example 66, the subject matter of any one or more of examples 61 to 65 may include, wherein the folding procedure comprises one or more of the following steps:
measuring the selected garment when in a spread stat producing updated sensor data associated with the selected garment, using the at least one detection subsystem;
receiving and analyzing the updated sensor data from the at least one detection subsystem, by the control subsystem;
determining object-properties of the selected garment, based on analysis of the received updated sensor data;
generating a customized folding plan, customized for the specific selected garment, based on the determined object-properties;
operating the SRD and/or the at least one gripper of the SRD, for folding of the selected garment, according to the generated folding plan of the selected garment.

In example 67, the subject matter of example 66 may include, wherein the folding procedure further comprises:
monitoring in real time or near real time execution of folding actions of the folding plan and/or of the folding process, for identification of folding-performances' impairments; and
determining, in real time or near real time, required mitigation of identified folding performances impairments;
performing the determined required mitigation by the SRD.

In example 68, the subject matter of any one or more of examples 61 to 67 may include, wherein the stacking procedure comprises one or more of the following steps:
determining a corresponding stack for the specific folded selected garment, based on one or more of determined object-properties of the selected garment;
generating a customized stacking plan for the selected garment, based on the determined corresponding stack and its associated properties; and
moving the selected garment to the corresponding stack based on the generated customized stacking plan.

In example 69, the subject matter of any one or more of examples 55 to 68 may include, wherein at least one of the at least one sensor of the detection subsystem is embedded in or attached to the SRD.

In example 70, the subject matter of any one or more of examples 55 to 69 may include, wherein the at least one sensor comprises at least one of: at least one camera; at least one proximity sensor; at least one accelerometer; at least one thermometer; at least one acoustic transducer; at least one pressure sensor, at least one load and/or force sensor; at least one current sensor, at least one absolute and/or relative encoder, at least one gyroscope, at least one magnetometer.

In example 71, the subject matter of any one or more of examples 55 to 70 may include, wherein the detection subsystem further comprises at least one pattern projector, configured to project light onto the object or part thereof, in one or more patterns, for assisting in detection of one or more object-properties of a garment.

In example 72, the subject matter of any one or more of examples 55 to 71 may include, wherein the at least one detection subsystem further comprises one or more operation-sensors configured to sense one or more properties of each of the at least one gripper, and wherein at least one of the one or more control units of the control subsystem is configured to receive and analyze updated sensor data arriving from the at least one operation-sensor and control the SRD and/or the at least one gripper, also based on analysis of the updated sensor data from the at least one operation-sensor.

In example 73, the subject matter of example 72 may include, wherein the one or more gripper-sensors comprise one or more of: a touch sensor, a tactile sensor, a proximity sensor, a gyroscope, a magnetometer, an accelerometer, an optical sensor, an acoustic transducer, a pressure sensor, a positioning sensor or system, an orientation sensor.

In example 74, the subject matter of any one or more of examples 72 to 73 may include, wherein the at least one gripper-sensor is configured to enable determining one or more gripper-properties of a corresponding gripper:
gripper position in the internal and/or external 3D coordinate system;
one or more gripping strength properties of the gripper;
relative position between the gripper and the garment or a part thereof.

In example 75, the subject matter of any one or more of examples 72 to 74 may include, wherein the at least one gripper-sensor is further configured to transmit updated sensor data associated with the corresponding gripper to the control subsystem, which is further configured to receive and analyze gripper-related updated sensor data to determine, based on received updated sensor data from the at least one gripper sensor and/or the one or more gripper-properties.

In example 76, the subject matter of any one or more of examples 55 to 75 may include, wherein at least one of the one or more control units comprises at least one of: a processor, at least one database or data storage unit, an analysis module, a control module.

In example 77, the subject matter of any one or more of examples 55 to 76 may include, wherein at least one sensor of at least one of the at least one detection subsystem is embedded in the SRD.

In example 78, the subject matter of any one or more of examples 55 to 77 may include, wherein at least one detection subsystem of the robotic system is embedded in the SRD and at least another detection subsystem of the robotic system is located externally to the SRD.

In example 79, the subject matter of any one or more of examples 55 to 78 may include, wherein the at least one control unit comprises a safety module configured to detect alarming situations based on analysis of received sensor data, using one or more safety algorithms.

In example 80, the subject matter of any one or more of examples 55 to 79 may include, wherein the control subsystem is configured for monitoring sensing and/or object-handling processes and/or performances based on analysis of sensor data.

In example 81x, the subject matter of example 80 may include, wherein the control subsystem is configured to determine sensor state of at least one sensor of the detection subsystem and adjust state of the respective sensor accordingly.

In example 82, the subject matter of example 81 may include, wherein the state of a sensor comprises one or more of: sensor positioning; sensor resolution; sensor zooming properties; sensor mode; sensor operation state; sensor field of view (FOV); sensor focusing properties; sensor sensitivity properties.

In example 83, the subject matter of any one or more of examples 55 to 82 may include, wherein the robotic system further comprises at least one braking mechanism for each suspension cable of the SRD, each braking mechanism being configured for passive or controllable active preventing of the respective suspension cable from continuing to be released.

In example 84, the subject matter of example 83 may include, wherein the braking mechanism comprises at least one braking element having a high-friction material that can be engaged with the suspension cable for braking a releasing thereof.

In example 85, the subject matter of any one or more of examples 55 to 84 may include, wherein the robotic system further comprises a docking station for releasable docking of the SRD thereover or thereby.

In example 86, the subject matter of example 85 may include, wherein the docking station is configured to connect the SRD to a power line for charging one or more chargeable batteries of the SRD.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1-83. (canceled)

84. A Robotic system (RS) comprising:
(i) a suspendable robotic device (SRD) configured to be suspended from a support structure by at least one cable;
(ii) a cable length-adjustment mechanism configured to controllably adjust the length of the at least one cable to vary the position of the SRD within a three-dimensional space; and
(iii) a displacement mechanism associated with the SRD and configured to displace the position of the at least one cable exit point relative to the SRD.

85. The robotic system of claim 84, wherein the displacement mechanism comprises:
a movable element carrying at least one cable guide element (CGE) through which the at least one cable is routed; and
an actuator configured to displace the movable element relative to the SRD, thereby adjusting the position of the cable exit point.

86. The robotic system of claim 84, further comprising:
a detection subsystem configured to acquire sensor data relating to at least one of: the SRD, an object to be manipulated, or the surrounding environment; and
a control subsystem configured to analyze the acquired data for use in positioning or operational control of the SRD.

87. The robotic system of claim 86, wherein the detection subsystem comprises one or more sensors selected from the group consisting of: optical sensors, tactile sensors, proximity sensors, distance sensors, inertial sensors, thermal sensors, acoustic sensors, pressure sensors, electrical sensors, or combinations thereof.

88. The robotic system of claim 86, further comprising a manipulation subsystem including one or more end effectors selected from the group consisting of: a gripper, a robotic arm, a suction device, a tool, a connector, or an end effector configured to manipulate, alter the physical state of, cut, iron, dry, or deodorize a fabric item or a plastic bag.

89. The robotic system of claim 88, wherein the manipulation subsystem comprises one or more sensors associated with at least one end effector, the sensors being configured to detect at least one of: contact, proximity, force, temperature, electrical conductivity, or color, and wherein the control subsystem is configured to analyze data from the sensors to determine an interaction state between the end effector and an object.

90. The robotic system of claim 86, wherein the control subsystem is configured to update one or more operational parameters of the robotic system based on analysis of previously acquired sensor data or past interactions, including through the application of machine learning techniques.

91. The robotic system of claim 84, further comprising a braking mechanism configured to selectively restrict or prevent movement of at least one of the suspension cables.

92. The robotic system of claim 89, wherein the robotic system is configured for folding garments from a laundry pile, and wherein the detection subsystem is configured to measure one or more properties of a selected garment, and the control subsystem is configured to:
(i) determine one or more object-related parameters of the selected garment based on the measured properties; and
(ii) control at least one of: a cable length-adjustment mechanism, a displacement mechanism, or the manipulation subsystem to perform a folding operation on the selected garment.

93. A method for folding garments of a laundry garments pile, the method comprising at least:
(a) providing a robotic system (RS) that comprises at least a suspendable robotic device (SRD) comprising at least one end effector and configured to be suspended from a support structure by at least one suspension cable in a controllable manner such that a robot body of the SRD can be position-controlled by controlling at least overall length of the at least one suspension cable of the SRD; at least one detection subsystem comprising one or more sensors; and a control subsystem configured at least for controlling operation of the SRD;
(b) selecting a garment from the laundry pile to be folded by the SRD;
(c) detecting a folding area;
(d) moving the selected garment to the folding area by controllably using at least one end effector of the SRD;
(e) spreading the garment in the folding area, by controllably using at least one end effector of the SRD;
(f) measuring the selected garment, using at least one sensor of the at least one detection subsystem;
(g) analyzing the received updated sensor data by the control subsystem of the RS;
(h) determining one or more object-properties of the selected garment, based on analysis of the received updated sensor data;
(i) generating a customized folding plan for the selected garment, based on analysis of the object-properties of the selected garment;
(j) operating the SRD for folding of the selected garment, according to the generated customized folding plan, wherein the operation of the SRD is controlled by the control subsystem.

94. The method of claim 93 further comprises determining a stack that is associated with the respective folded selected garment and moving the folded selected garment when in a folded state to the determined associated stack.

95. A system for folding garments, comprising:
a robotic system (RS) including a suspendable robotic device (SRD) configured to be suspended from a support structure by at least one cable; and
a control unit configured to operate the SRD to manipulate at least one garment and to perform at least one fold of the garment.

96. The system of claim 95, wherein the robotic system further comprises a displacement mechanism associated with the SRD and configured to displace a cable exit point of at least one suspension cable relative to the SRD.

97. The system of claim 96, wherein the displacement mechanism comprises:
a movable element carrying at least one cable guide element (CGE) through which the at least one cable is routed; and
an actuator configured to displace the movable element relative to the SRD, thereby adjusting the position of the cable exit point in a predetermined direction.

98. The robotic system of claim 95, further comprising:
a detection subsystem configured to acquire sensor data relating to at least one of: the SRD, an object to be manipulated, or the surrounding environment; and
a control subsystem configured to analyze the acquired data for use in positioning or operational control of the SRD.

99. The robotic system of claim 98, wherein the detection subsystem comprises one or more sensors selected from the group consisting of: optical sensors, tactile sensors, proximity sensors, distance sensors, inertial sensors, thermal sensors, acoustic sensors, pressure sensors, electrical sensors, or combinations thereof.

100. The robotic system of claim 95, further comprising a manipulation subsystem including one or more end effectors selected from the group consisting of: a gripper, a robotic arm, a suction device, a tool, a connector, or an end effector configured to manipulate, alter the physical state of, cut, iron, dry, or deodorize a fabric item or a plastic bag.

101. The robotic system of claim 100, wherein the manipulation subsystem comprises one or more sensors associated with at least one end effector, the sensors being configured to detect at least one of: contact, proximity, force, temperature, electrical conductivity, or color, and wherein the control subsystem is configured to analyze data from the sensors to determine an interaction state between the end effector and an object.
